(19) United States
(12) Patent Application Publication
(10) Pub. No.: US 2024/0138196 A1
(43) Pub. Date: Apr. 25, 2024

(54) DISPLAY DEVICE

(71) Applicant: Samsung Display Co., Ltd., Yongin-si (KR)

(72) Inventors: KWANG SOO BAE, Yongin-si (KR); Gun Hee Kim, Yongin-si (KR); Sun Hee Lee, Yongin-si (KR); Min Oh Choi, Yongin-si (KR)

(21) Appl. No.: 18/370,419

(22) Filed: Sep. 19, 2023

(30) Foreign Application Priority Data
Oct. 19, 2022 (KR) 10-2022-0135628

(51) Int. Cl. H10K 59/122; G06F 21/32; G06V 40/13; H10K 59/38; H10K 59/40; H10K 59/65; H10K 59/80

(52) U.S. Cl. CPC H10K 59/122; G06F 21/32; G06V 40/1306; H10K 59/38; H10K 59/40; H10K 59/65; H10K 59/873; H10K 59/8792

(57) ABSTRACT

A display device including a display panel including a display area including emission areas and a non-emission area adjacent to the emission areas, wherein the display panel includes: a pixel defining layer that includes first openings corresponding to the emission areas and a second opening corresponding to the non-emission area; light emitting elements each including a first electrode, a second electrode, and a light emitting layer disposed between the first electrode and the second electrode, wherein each of the light emitting elements is disposed in a corresponding one of the first openings; and a photovoltaic element including a first cell electrode, a second cell electrode, and an optical photovoltaic layer disposed between the first cell electrode and the second cell electrode, wherein the photovoltaic element is disposed in the second opening.

### CROSS-REFERENCE TO RELATED APPLICATION

This U.S. non-provisional patent application claims priority under 35 U.S.C. § 119 to Korean Patent Application No. 10-2022-0135628, filed on Oct. 20, 2022, the disclosure of which is incorporated by reference herein in its entirety.

### TECHNICAL FIELD

The present disclosure relates to a display device, and more particularly, to a display device designed to lower power consumption.

### DISCUSSION OF RELATED ART

The display device provides diverse functions that facilitate interactive communication with users, such as providing information to users through visual display or detecting a user's input. In addition, modern display devices have the ability to detect a user's biometric information.

Methods for detecting biometric information include a capacitive method, an optical method and an ultrasonic method. The capacitive method detects changes in capacitance formed between electrodes, the optical method detects incident light using an optical sensor, and the ultrasonic method senses vibration using a piezoelectric material. Due to the display device includes various functions, techniques are being developed to supplement power consumption in addition to the existing power supply module.

### SUMMARY

The present disclosure provides a display device that includes a photovoltaic element disposed in an active area, resulting in decreased power consumption.

An embodiment of the inventive concept provides a display device including a display panel including a display area including emission areas and a non-emission area adjacent to the emission areas, wherein the display panel includes: a pixel defining layer that includes first openings corresponding to the emission areas and a second opening corresponding to the non-emission area; light emitting elements each including a first electrode, a second electrode, and a light emitting layer disposed between the first electrode and the second electrode, wherein each of the light emitting elements is disposed in a corresponding one of the first openings; and a photovoltaic element including a first cell electrode, a second cell electrode, and an optical photovoltaic layer disposed between the first cell electrode and the second cell electrode, wherein the photovoltaic element is disposed in the second opening.

The first electrodes and the first cell electrode are disposed on the same layer.

The second electrode and the second cell electrode are integral.

The display device further includes a protection layer disposed on the second electrode and the second cell electrode.

The second opening is provided in plural, and the first cell electrode and the optical photovoltaic layer are provided in plural, wherein a portion of each of the first cell electrodes is disposed in a corresponding second opening among the second openings, and each of the optical photovoltaic layers is disposed in a corresponding second opening among the second openings.

The pixel defining layer overlaps the non-emission area and forms third openings spaced apart from the second openings, and the display panel includes optical sensors each including a light detection element including a first sensor electrode, a second sensor electrode, and a light receiving layer disposed between the first sensor electrode and the second sensor electrode and disposed in a corresponding third opening among the third openings, and a sensor driving unit including at least one transistor.

An area of at least one of the second openings and an area of at least one of the third openings are different from each other.

The second opening is a single opening and a shape of the optical photovoltaic layer corresponds to a shape of the non-emission area.

The display device further includes an encapsulation layer including a first inorganic layer covering the light emitting elements, a second inorganic layer, and an organic layer disposed between the first inorganic layer and the second inorganic layer.

The display device further includes an input detection layer including conductive layers and a detection insulating layer, and disposed on the encapsulation layer.

The display device further includes a color filter layer including a light blocking layer overlapping the pixel defining layer and color filters overlapping a corresponding emission area among the emission areas.

The display device further includes an optical member including an antireflection film, a polarizing film, or a gray filter and disposed on the input detection layer.

The photovoltaic element further includes a cell hole control layer disposed between the first cell electrode and the optical photovoltaic layer and a cell electron control layer disposed between the optical photovoltaic layer and the second cell electrode.

Each of the light emitting elements further comprises a hole control layer disposed between the first electrode and the light emitting layer and an electron control layer disposed between the light emitting layer and the second electrode, and the electron control layer, the cell electron control layer, the hole control layer, or the cell hole control layer has an integral shape.

An embodiment of the inventive concept provides a display device including a display panel including a display area including emission areas and a non-emission area adjacent to the emission areas, wherein the display panel includes: a pixel defining layer including openings that correspond to respective emission areas and overlap the non-emission area; light emitting elements each including a first electrode, a second electrode, and a light emitting layer disposed between the first electrode and the second electrode, wherein each of the light emitting elements is disposed in a corresponding one of the openings; an encapsulation layer covering the light emitting elements; a partition wall layer including a first partition wall opening overlapping a portion of the pixel defining layer and second partition wall openings corresponding to respective openings, wherein the partition wall layer is disposed on the encapsulation layer; and a photovoltaic element including a first cell electrode, a second cell electrode, and an optical photovoltaic layer disposed between the first cell electrode and the second cell electrode, wherein the photovoltaic element is disposed in the first partition wall opening.

The display device further includes a cell inorganic layer disposed on the encapsulation layer and covering the photovoltaic element, and a cell organic layer disposed on the cell inorganic layer.

The display device further includes: an input detection layer including a first detection insulating layer disposed on the cell organic layer; a first conductive layer overlapping the non-emission area and disposed on the first detection insulating layer; a second detection insulating layer disposed on the first detection insulating layer and covering the first conductive layer; a second conductive layer including a plurality of conductive lines overlapping the pixel-defining film and disposed on the second detection insulating layer; and a third detection insulating layer disposed on the second conductive layer and covering the second conductive layer.

The conductive lines have a mesh shape, and the optical photovoltaic layer has a shape corresponding to the mesh shape.

The first conductive layer includes a bridge pattern connected to corresponding conductive lines among the conductive lines through a contact hole in the second detection insulating layer, and the second cell electrode has a shape corresponding to the bridge pattern.

A line width of the second detection electrode is greater than a line width of the bridge pattern.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a perspective view of a display device according to an embodiment of the inventive concept;

FIG. 1B is a perspective view of a display device according to an embodiment of the inventive concept;

FIG. 2A is a cross-sectional view of a display device according to an embodiment of the inventive concept;

FIG. 2B is a cross-sectional view of a display device according to an embodiment of the inventive concept;

FIG. 2C is a cross-sectional view of a display device according to an embodiment of the inventive concept;

FIG. 3A is a block diagram of a display device according to an embodiment of the inventive concept;

FIG. 3B is an equivalent circuit diagram of a pixel according to an embodiment of the inventive concept;

FIG. 4A is a plan view of a display device according to an embodiment of the inventive concept;

FIG. 4B is a cross-sectional view of a display device according to an embodiment of the inventive concept;

FIG. 5A is a block diagram of a display device according to an embodiment of the inventive concept;

FIG. 5B is an equivalent circuit diagram of a pixel and a sensor according to an embodiment of the inventive concept;

FIG. 6A is a plan view of a display device according to an embodiment of the inventive concept;

FIG. 6B is a cross-sectional view of a display device according to an embodiment of the inventive concept;

FIG. 7A is a plan view of a display device according to an embodiment of the inventive concept;

FIG. 7B is a cross-sectional view of a display device according to an embodiment of the inventive concept;

FIG. 8A is a plan view of an input detection layer according to an embodiment of the inventive concept;

FIG. 8B is an enlarged plan view of a region of an input detection layer according to an embodiment of the inventive concept;

FIG. 9 is a cross-sectional view of a display device according to an embodiment of the inventive concept;

FIG. 10 is a plan view illustrating a spatial arrangement between an input detection layer and an optical photovoltaic layer according to an embodiment of the inventive concept; and

FIG. 11 is a plan view illustrating a spatial arrangement between an input detection layer and an optical photovoltaic layer according to an embodiment of the inventive concept.

### DETAILED DESCRIPTION OF THE EMBODIMENTS

In this specification, when an element (or region, layer, part, etc.) is referred to as being “on”, “connected to”, or “coupled to” another element, it may mean that the element is directly one, connected to, or coupled to the other component, or a third component is arranged between them.

Like reference numerals may refer to like elements. Additionally, in the drawings, the thicknesses, proportions, and dimensions of components may be exaggerated for effective description. “And/or” includes all of one or more combinations defined by related components.

It will be understood that the terms “first” and “second” are used herein to describe various components but these components should not be limited by these terms. The above terms are used to distinguish one component from another. For example, a first component may be referred to as a second component and vice versa. The terms of a singular form may include plural forms unless otherwise specified.

In addition, terms such as “below”, “the lower side”, “on”, and “the upper side” are used to describe a relationship of components shown in a particular drawing. These terms are described as a relative concept based on a direction shown in the particular drawing.

In various embodiments of the inventive concept, the term “include,” “comprise,” “including,” or “comprising,” specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which this inventive concept belongs. In addition, terms such as terms defined in commonly used dictionaries should be interpreted as having a meaning consistent with their meaning in the context of the related technology, and it should not be construed in an overly ideal or overly formal sense unless explicitly defined here.

Hereinafter, embodiments of the inventive concept will be described with reference to the drawings.

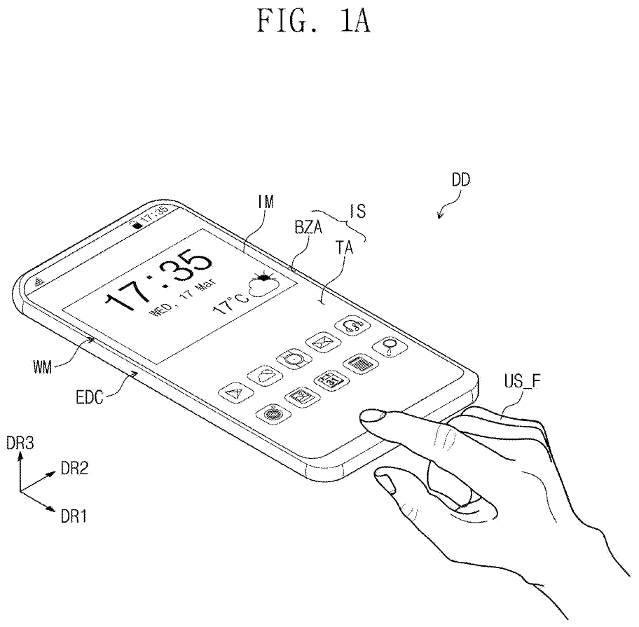

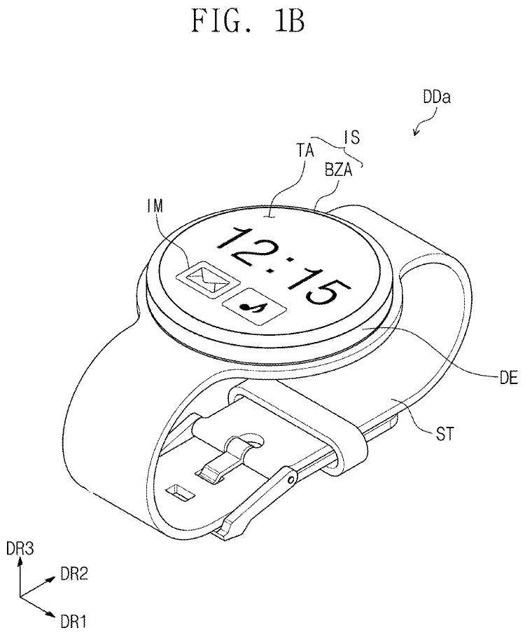

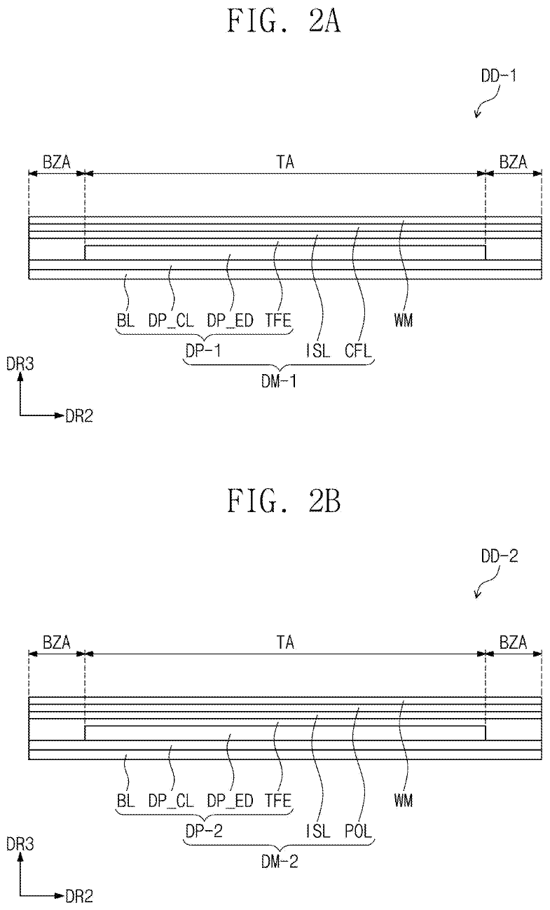

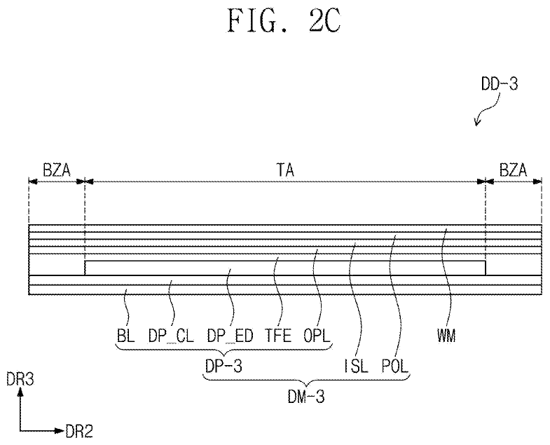

FIG. 1A is a perspective view of a display device according to an embodiment of the inventive concept. FIG. 1B is a perspective view of a display device according to an embodiment of the inventive concept. FIG. 2A is a cross-sectional view of a display device according to an embodiment of the inventive concept. FIG. 2B is a cross-sectional view of a display device according to an embodiment of the inventive concept. FIG. 2C is a cross-sectional view of a display device according to an embodiment of the inventive concept. Referring to FIG. 1A, a display device DD according to an embodiment of the inventive concept may have a rectangular shape having long sides parallel to a first direction DR1 and short sides parallel to a second direction DR2 intersecting the first direction DR1. However, the inventive concept is not limited thereto, and the display device DD may have various shapes such as a circle and a polygon.

The display device DD may be a device that is activated according to an electrical signal. The display device DD may be applied to various electronic devices. For example, the display device DD may be applied to electronic devices such as tablets, laptop computers, computers, smart televisions, and wearable electronic devices.

Hereinafter, a normal direction perpendicular to a plane formed by the first direction DR1 and the second direction DR2 is referred to as a third direction DR3. In this specification, “when viewed from the plane” may mean a state viewed from the third direction DR3.

The upper surface of the display device DD may be the display surface IS and may have a plane formed by the first direction DR1 and the second direction DR2. Images IM generated by the display device DD may be provided to a user through the display surface IS.

The display surface IS may be divided into a transmission area TA and a bezel area BZA. The transmission area TA may be an area in which images IM are displayed. The user recognizes the images IM through the transmission area TA. In this embodiment, the transmission area TA is illustrated in a rectangular shape with rounded vertices. However, this is merely an example, and the transmission area TA may have various shapes, and is not limited to any one embodiment.

The bezel area BZA is adjacent to the transmission area TA. The bezel area BZA may have a predetermined color. The bezel area BZA may surround the transmission area TA. Accordingly, the shape of the transmission area TA may be substantially defined by the bezel area BA. However, this is illustrated as an example, and the bezel area BZA may be disposed adjacent to only one side of the transmission area TA, or may be omitted.

The display device DD may sense an external input applied from the outside. The external input may include various types of inputs provided from the outside of the display device DD. For example, the external input may include an external input (e.g., hovering) that is applied close to or spaced a predetermined distance from the display device DD as well as contact by a portion of the body, such as the user's hand US_F. In addition, the external input may have various forms such as force, pressure, temperature, light, and the like.

The display device DD according to an embodiment may detect a user's biometric information applied from the outside. A biometric information detection area capable of detecting the user's biometric information may be provided on the display surface IS of the display device DD. In other words, the display surface IS may include a designated area for biometric information detection. The biometric information detection area may be provided in the entire area of the transmission area TA or may be provided in a partial area of the transmission area TA. FIG. 1A illustrates that the entire transmission area TA is utilized as a biometric information detection area, but the inventive concept is not limited thereto, and a biometric information detection area may be provided in a portion of the transmission area TA. For example, a portion of the transmission area TA may be designated as the biometric information detection area. The biometric information may correspond to, for example, user fingerprint information.

The display device DD may include a window WM, a display module, and a housing EDC. In the present embodiment, the window WM and the housing EDC are combined to form an exterior of the display device DD.

The front surface of the window WM forms the display surface IS of the display device DD. The window WM may include an optically transparent insulating material. For example, the window WM may include glass or plastic. The window WM may have a multilayer structure or a single layer structure. For example, the window WM may include a plurality of plastic films bonded with an adhesive, or may include a glass substrate and a plastic film bonded with an adhesive.

The display module may include a display panel and an input detection layer. The display panel may display an image according to an electrical signal, and the input detection layer may detect an external input applied from the outside. The external input may be provided in various forms. The display panel according to an embodiment of the inventive concept may include a photovoltaic element that generates a photoelectric phenomenon by receiving sunlight provided to the transmission area TA. In other words, the display panel may incorporate a photovoltaic element that utilizes the sunlight received in the transmission area TA to generate a photoelectric phenomenon.

A display panel included in a display module according to an embodiment of the inventive concept may be a light emitting display panel and is not particularly limited. For example, the display panel may be an organic light emitting display panel, an inorganic light emitting display panel, or a quantum dot light emitting display panel. The light emitting layer of the organic light emitting display panel may include an organic light emitting material, and the light emitting layer of the inorganic light emitting display panel may include an inorganic light emitting material. The light emitting layer of the quantum dot light emitting display panel may include a quantum dot, a quantum rod, and the like. Hereinafter, the display panel is described as the organic light emitting display panel.

The housing EDC is coupled to the window WM. The housing EDC is coupled to the window WM to provide a predetermined internal space. The display module may be accommodated in the inner space. The housing EDC may include a material having relatively high rigidity. For example, the housing EDC may include a plurality of frames and/or plates made of glass, plastic, or metal, or a combination thereof. The housing EDC may stably protect components of the display device DD accommodated in the internal space from external impact. In the display device DD according to an embodiment, a battery module or the like may be disposed to power the overall operation of the display module.

Referring to FIG. 1B, a display device DDa according to an embodiment of the inventive concept may be a wearable electronic device. FIG. 1B shows a smart watch as an example of a wearable electronic device.

The display device DDa may display time information, weather information, a call, or an image IM for performing various applications or operations. A display surface IS of the display device DDa may be divided into a transmission area TA and a bezel area BZA. A user may operate the electronic device DDa through a touch operation. The display device DDa may include a main body DE and a strap ST for fixing the main body DE to the user's body. The strap ST may be separated from and replaced with the main body DE.

The main body DE may include a display panel and an input detection layer such as the display device DD described with reference to FIG. 1A. The exterior of the main body DE may have a circle shape. However, the embodiment of the inventive concept is not limited thereto, and the exterior of the main body DE may have a square shape with rounded corners. Embodiments of a display device to be described below may be applied to the display devices DD and DDa described with reference to FIGS. 1A and 1B; however, the inventive concept is not limited thereto.

Referring to FIG. 2A, a display device DD-1 according to an embodiment may include a display module DM-1 and a window WM. The display module DM-1 may include a display panel DP-1, an input detection layer ISL, and a color filter layer CFL.

The display panel DP-1 includes a base layer BL, a circuit layer DP_CL, a display element layer DP_ED, and an encapsulation layer TFE. The display panel DP-1 according to the inventive concept may be a flexible display panel. However, the embodiment of the inventive concept is not limited thereto. For example, the display panel DP-1 may be a foldable display panel or a rigid display panel that is folded about a folding axis.

The base layer BL may include a synthetic resin layer. The synthetic resin layer may be a polyimide resin layer, and the material thereof is not particularly limited. In addition, the base layer BL may include a glass substrate, a metal substrate, or an organic/inorganic composite material substrate.

The circuit layer DP_CL is disposed on the base layer BL. The circuit layer DP_CL includes at least one insulating layer and a circuit element. Hereinafter, the insulating layer included in the circuit layer DP_CL is referred to as an intermediate insulating layer. The intermediate insulating layer includes at least one intermediate inorganic layer and at least one intermediate organic layer. The circuit element may include a pixel driving circuit included in each of a plurality of pixels for displaying an image and a sensor driving circuit included in each of a plurality of sensors for recognizing external information. The external information may be biometric information.

As an example of the inventive concept, the sensor may be a fingerprint recognition sensor, a proximity sensor, an iris recognition sensor, or the like. In addition, the sensor may be an optical sensor that recognizes biometric information in an optical manner. The circuit layer DP_CL may further include a pixel driving unit including a pixel driving circuit, a sensor driving unit including a sensor driving circuit, and signal lines connected thereto.

The display element layer DP_ED may include a light emitting element included in each of the pixels, a light detection element included in each of the sensors, and a photovoltaic element included in each optical photovoltaic. As an example of the inventive concept, the light sensing element may be a photodiode. The optical fingerprint sensor may detect light reflected by the user's fingerprint. The photovoltaic element may correspond to an optical photovoltaic that generates electrical energy based on externally input sunlight. A detailed description related to the display element layer DP_ED will be described later.

The encapsulation layer TFE encapsulates the display element layer DP_ED. The encapsulation layer TFE may include at least one organic layer and at least one inorganic layer. The inorganic layer may include an inorganic material and may protect the display element layer DP_ED from moisture/oxygen. The inorganic film may include a silicon nitride layer, a silicon oxynitride layer, a silicon oxide layer, a titanium oxide layer, or an aluminum oxide layer, but is not particularly limited thereto. The organic layer may include an organic material, and may protect the display element layer DP_ED from foreign substances such as dust particles.

The input detection layer ISL may be formed on the display panel DP-1. The input detection layer ISL may be directly disposed on the encapsulation layer TFE. According to an embodiment of the inventive concept, the input detection layer ISL may be formed on the display panel DP by a continuous process. In other words, when the input detection layer ISL is directly disposed on the display panel DP-1, an adhesive film is not disposed between the input detection layer ISL and the encapsulation layer TFE.

However, alternatively, an adhesive film may be disposed between the input detection layer ISL and the display panel DP-1. In this case, the input detection layer ISL is not manufactured by a continuous process with the display panel DP-1. For example, after being manufactured through a process separate from that of the display panel DP-1, the input detection layer ISL may be fixed to the upper surface of the display panel DP-1 by an adhesive film.

The input detection layer ISL may detect an external input (for example, a user's touch), change the detected external input into a predetermined input signal, and provide the input signal to the display panel DP-1. In other words, the input detection layer ISL can sense external inputs such as a user's touch, convert the input into a predetermined signal, and transmit it to the display panel DP-1. The input detection layer ISL may include a plurality of detection electrodes for detecting an external input. The detection electrodes may detect an external input in a capacitive manner. The display panel DP-1 may receive an input signal from the input detection layer ISL and generate an image corresponding to the input signal.

The display module DM-1 according to this embodiment may include the color filter layer CFL. As an example of the inventive concept, the color filter layer CFL may be disposed on the input detection layer ISL. However, the embodiment of the inventive concept is not limited thereto. The color filter layer CFL may be disposed between the display panel DP and the input detection layer ISL. The color filter layer CFL may include a plurality of color filters.

Referring to FIG. 2B, a display device DD-2 according to an embodiment may include a display module DM-2 and a window WM. The display module DM-2 may include a display panel DP-2, an input detection layer ISL, and an optical member POL. The display panel DP-2 includes a base layer BL, a circuit layer DP_CL, a display element layer DP_ED, and an encapsulation layer TFE. Descriptions of the window WM, the display panel DP-2, and the input detection layer ISL may correspond to the window WM, the display panel DP-1, and the input detection layer ISL described with reference to FIG. 1A.

The optical member POL according to the present embodiment may be disposed on the input detection layer ISL. The optical member POL may be directly disposed on the input detection layer ISL. The optical member POL may include at least one of an antireflection film, a polarizing film, and a gray filter for reducing reflectance of external light. The polarizing film may include a retarder and/or a polarizer.

In comparison to the display module DM-2 in which the optical member POL is disposed on the display panel DP-2, in the display panel DP-1 described with reference to FIG. 1A, the amount of sunlight incident on the transmission area TA of the window WM may be greater than that of the display module DM-1 on which the color filter layer CFL is disposed.

Referring to FIG. 2C, a display device DD-3 according to an embodiment may include a display module DM-3 and a window WM. The display module DM-3 may include a display panel DP-3, an input detection layer ISL, and an optical member POL. The display panel DP-3 includes a base layer BL, a circuit layer DP_CL, a display element layer DP_ED, and an encapsulation layer TFE. The display panel DP-3 according to the present embodiment may further include a solar cell layer OPL.

Descriptions of the window WM, the base layer BL, the circuit layer DP_CL, the display element layer DP_ED, the encapsulation layer TFE, the input detection layer ISL, and the optical member POL may correspond to the window WM, the base layer BL, the circuit layer DP_CL, the display element layer DP_ED, the encapsulation layer TFE, the input detection layer ISL, and the optical member POL described with reference to FIGS. 1A to 2B.

The solar cell layer OPL may be placed between the encapsulation layer TFE and the input detection layer ISL. The solar cell layer OPL may be in direct contact with the encapsulation layer TFE and the input detection layer ISL. The solar cell layer OPL may include a photovoltaic element that receives sunlight from the transmission area TA and produces a photoelectric phenomenon. A description of the photovoltaic element will be given later.

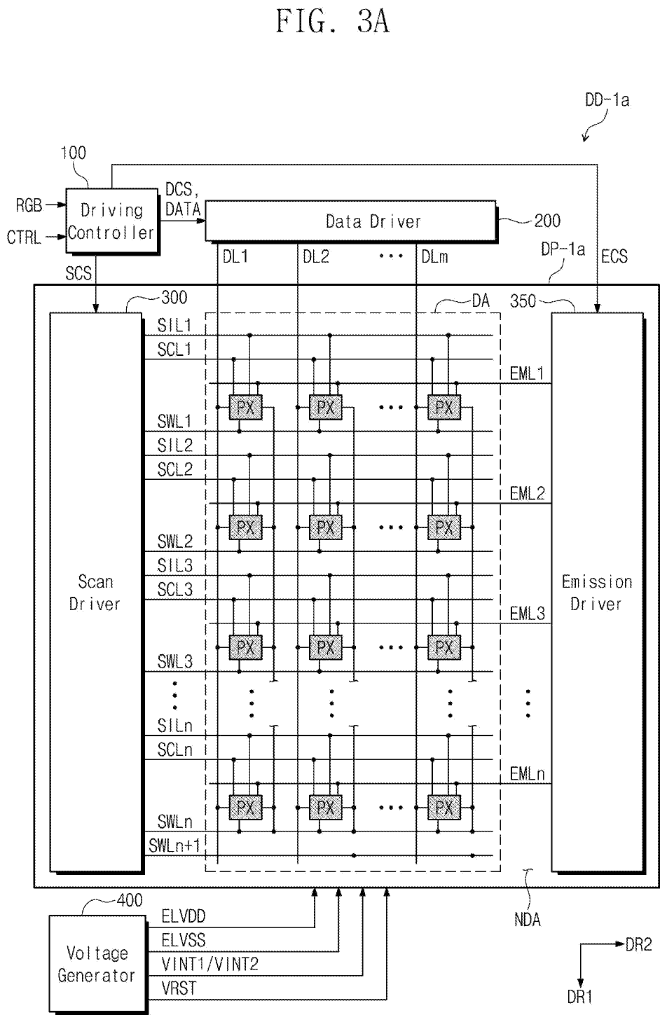

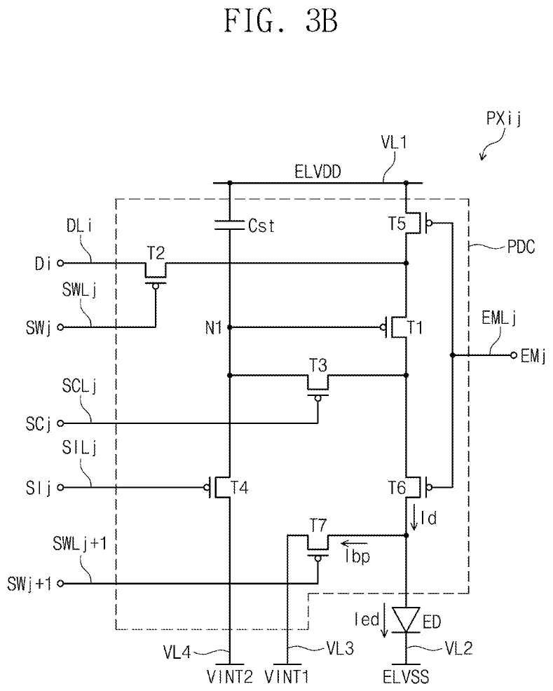

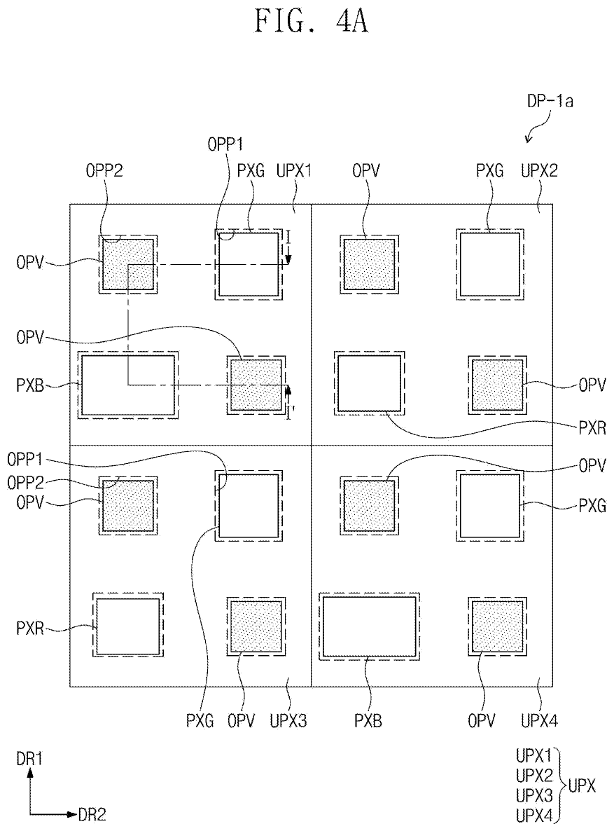

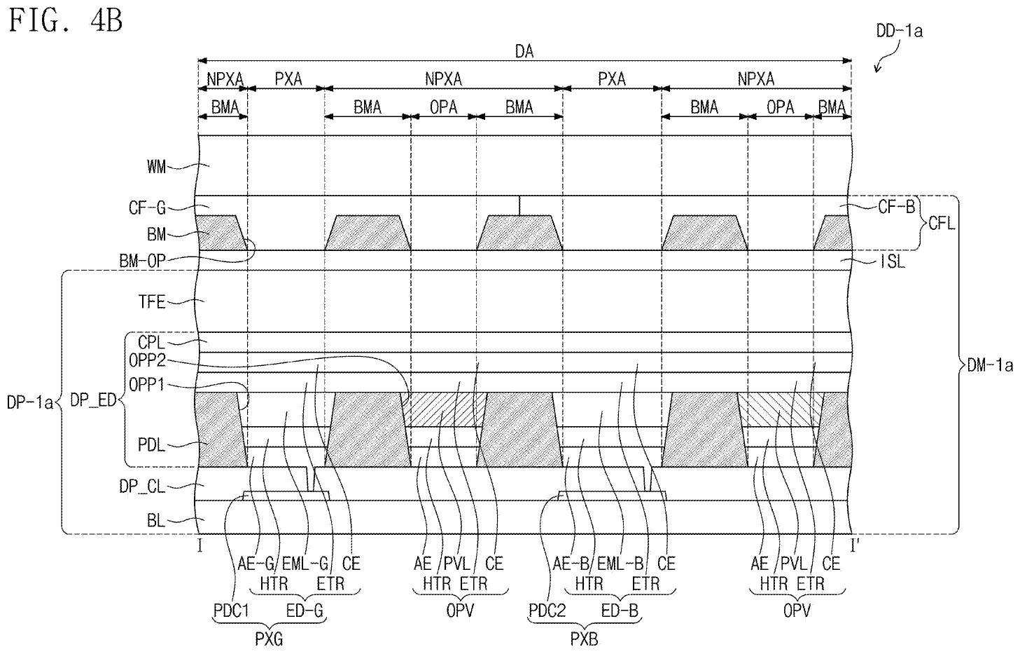

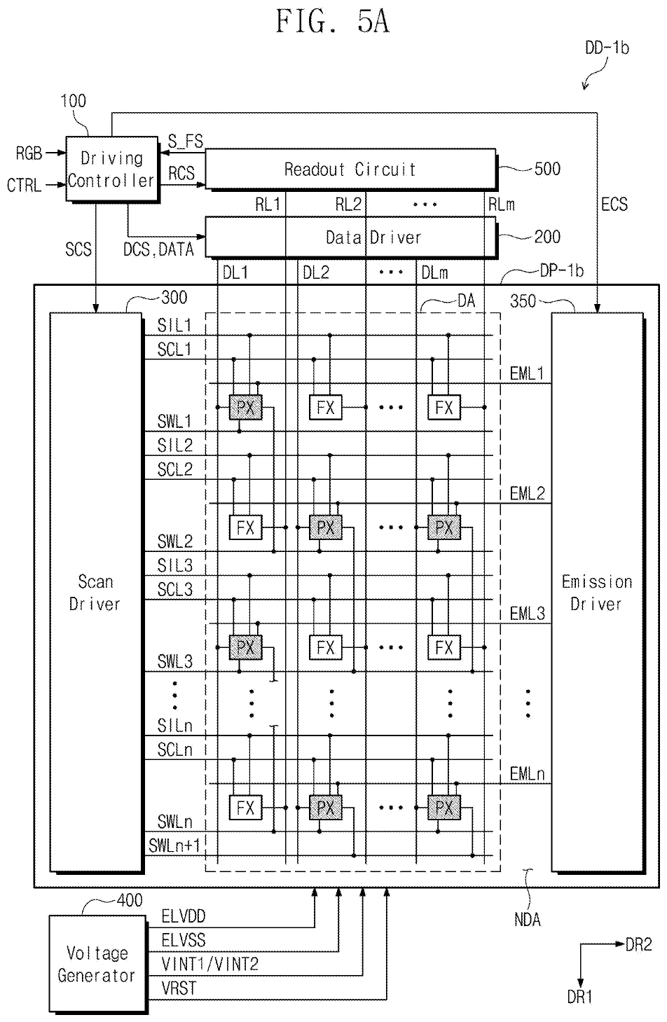

FIG. 3A is a block diagram of a display device according to an embodiment of the inventive concept. FIG. 3B is an equivalent circuit diagram of a pixel according to an embodiment of the inventive concept. FIG. 4A is a plan view illustrating a display device according to an embodiment of the inventive concept. FIG. 4B is a cross-sectional view of a display device according to an embodiment of the inventive concept. A stacked structure of the display device DD-1a described with reference to FIGS. 3A to 4B may correspond to the display device DD-1 described with reference to FIG. 2A.

Referring to FIGS. 3A and 3B, a display device DD-1a according to an embodiment includes a display panel DP-1a, a panel driver, and a driving controller 100. In an embodiment of the inventive concept, the panel driver includes a data driver 200, a scan driver 300, an emission driver 350, and a voltage generator 400.

The driving controller 100 receives an image signal RGB and a control signal CTRL. The driving controller 100 generates an image data signal DATA obtained by converting a data format of the image signal RGB to meet the specification of an interface with the data driver 200. The driving controller 100 outputs a first control signal SCS, a second control signal ECS, and a third control signal DCS.

The data driver 200 receives the third control signal DCS and the image data signal DATA from the driving controller 100. The data driver 200 converts the image data signal DATA into data signals, and outputs the data signals to a plurality of data lines DL1 to DLm, which will be described later. The data signals are analog voltages corresponding to the grayscale value of the image data signal DATA.

The scan driver 300 receives the first control signal SCS from the driving controller 100. The scan driver 300 may output scan signals to scan lines in response to the first control signal SCS.

The voltage generator 400 generates voltages necessary for the operation of the display panel DP-1a. In other words, the voltage generator 400 produces the necessary voltages to power the display panel DP. In this embodiment, the voltage generator 400 generates a first driving voltage ELVDD, a second driving voltage ELVSS, a first initialization voltage VINT1, a second initialization voltage VINT2, and a reset voltage VRST.

The display panel DP-1a may include a display area DA corresponding to a transmission area TA (see FIG. 1A) and a non-display area NDA corresponding to a bezel area BZA (see FIG. 1A).

The display panel DP-1a may include a plurality of pixels PX disposed in the display area DA. In an embodiment of the inventive concept, the plurality of pixels PX may be alternately disposed in the first and second directions DR1 and DR2.

The display panel DP-1a may include initialization scan lines SIL1 to SILn, compensation scan lines SCL1 to SCLn, write scan lines SWL1 to SWLn+1, emission control lines EML1 to EMLn, and the data lines DL1 to DLm.

The initialization scan lines SIL1 to SILn, the compensation scan lines SCL1 to SCLn, the write scan lines SWL1 to SWLn+1, and the emission control lines EML1 to EMLn extend in the second direction DR2. The initialization scan lines SIL1 to SILn, the compensation scan lines SCL1 to SCLn, the write scan lines SWL1 to SWLn+1, and the emission control lines EML1 to EMLn are arranged spaced apart from each other in the first direction DR1. The data lines DL1 to DLm extend in the first direction DR1 and are spaced apart from each other in the second direction DR2.

The plurality of pixels PX are electrically connected to the initialization scan lines SIL1 to SILn, the compensation scan lines SCL1 to SCLn, the write scan lines SWL1 to SWLn+1, the emission control lines EML1 to EMLn, and the data lines DL1 to DLm, respectively.

Each of the plurality of pixels PX may be electrically connected to four scan lines. For example, as shown in FIG. 3A, the pixels PX in the first row may be connected to the first initialization scan line SILL, the first compensation scan line SCL1, and the first and second write scan lines SWL1 and SWL2. In addition, the pixels PX in the second row may be connected to the second initialization scan line SIL2, the second compensation scan line SCL2, and the second and third write scan lines SWL2 and SWL3. However, the connection relationship between the pixels PX and the scan lines is not limited thereto.

The scan driver 300 may be disposed in the non-display area NDA of the display panel DP-1a. The scan driver 300 receives the first control signal SCS from the driving controller 100. The first control signal SCS may include a start signal and a plurality of clock signals. In response to the first control signal SCS, the scan driver 300 may output initial scan signals to initial scan lines SIL1 to SILn, output compensation scan signals to compensation scan lines SCL1 to SCLn, and output write scan signals to write scan lines SWL1 to SWLn+1.

The emission driver 350 may be disposed in the non-display area NDA of the display panel DP-1a. The emission driver 350 receives the second control signal ECS from the driving controller 100. The emission driver 350 may output emission control signals to the emission control lines EML1 to EMLn in response to the second control signal ECS. Alternatively, the scan driver 300 may be connected to the emission control lines EML1 to EMLn. In this case, the scan driver 300 may output emission control signals to the emission control lines EML1 to EMLn.

FIG. 3B shows an equivalent circuit diagram of a pixel PXij among the plurality of pixels PX shown in FIG. 3A. Since each of the plurality of pixels PX has the same circuit structure, a detailed description of the remaining pixels will be omitted as a description of the circuit structure of the pixel PXij will suffice.

The pixel PXij is connected to an i-th data line DLi (hereinafter referred to as a data line) among the data lines DL1 to DLm, a j-th initialization scan line SILj (hereinafter referred to as an initialization scan line) among the initialization scan lines SIL1 to SILn, a j-th compensation scan line SCLj (hereinafter referred to as a compensation scan line) among the compensation scan lines SCL1 to SCLn, j-th and (j+1)-th scan lines SWLj and SWLj+1 (hereinafter referred to as first and second write scan lines) among the write scan lines SWL1 to SWLn, and a j-th emission control line EMLj (hereinafter, referred to as an emission control line) among the emission control lines EML1 to EMLn.

The pixel PXij includes a light emitting element ED and a pixel circuit PDC. The light emitting element ED may be a light emitting diode. In an embodiment of the inventive concept, the light emitting element ED may be an organic light emitting diode including an organic light emitting layer. A current passing through the light emitting element ED is illustrated as led in FIG. 3B.

The pixel driving unit PDC includes first to seventh transistors T1, T2, T3, T4, T5, T6, and T7 and one capacitor Cst. All of the first to seventh transistors T1 to T7 may be P-type transistors. Alternatively, all of the first to seventh transistors T1 to T7 may be N-type transistors. The pixel driving unit PDC may be disposed on the circuit layer DP_CL described with reference to FIG. 2A.

In an embodiment, each of the first to seventh transistors T1 to T7 may be a transistor having a low-temperature polycrystalline silicon (LTPS) semiconductor layer. Some of the first to seventh transistors T1 to T7 may be P-type transistors, and others of the first to seventh transistors T1 to T7 may be N-type transistors. For example, among the first to seventh transistors T1 to T7, the first, second, and fifth to seventh transistors T1, T2, and T5 to T7 may be PMOS transistors, and the third and fourth transistors T3 and T4 may be NMOS transistors using an oxide semiconductor as a semiconductor layer. In an embodiment, at least one of the first to seventh transistors T1 to T7 may be an N-type transistor and the remainder of the first to seventh transistors T1 to T7 may be a P-type transistor.

The initialization scan line SILj, the compensation scan line SCLj, the first and second write scan lines SWLj and SWLj+1, and the emission control line EMLj may respectively transmit a j-th initialization scan signal SIj (hereinafter referred to as initialization scan signal), a j-th compensation scan signal SCj (hereinafter referred to as compensation scan signal), j-th and j+1-th write scan signals SWj and SWj+1 (hereinafter referred to as first and second write scan signals), and a j-th emission control signal EMj (hereinafter referred to as emission control signal) to the pixel PXij. The data line DLi transmits the data signal Di to the pixel PXij. The data signal Di may have a voltage level corresponding to the image signal RGB input to the display device DD-1a.

First and second driving voltage lines VL1 and VL2 may transmit the first driving voltage ELVDD and the second driving voltage ELVSS to the pixel PXij, respectively. In addition, first and second initialization voltage lines VL3 and VL4 may respectively transmit the first initialization voltage VINT1 and the second initialization voltage VINT2 to the pixel PXij.

The first transistor T1 is connected between the first driving voltage line VL1 receiving the first driving voltage ELVDD and the light emitting element ED. The first transistor T1 includes a first electrode connected to the first driving voltage line VL1 through the fifth transistor T5, a second electrode electrically connected to the anode of the light emitting element ED through the sixth transistor T6, and a third electrode connected to a first end of the capacitor Cst. The third electrode of the first transistor T1 may be a gate electrode. The first transistor T1 may receive the data signal Di transmitted from the data line DL according to the switching operation of the second transistor T2 and supply a driving current Id to the light emitting element ED.

The second transistor T2 is connected between the data line DLi and the first electrode of the first transistor T1. The second transistor T2 includes a first electrode connected to the data line DLi, a second electrode connected to the first electrode of the first transistor T1, and a third electrode connected to the first write scan line SWLj. The third electrode of the second transistor T2 may be a gate electrode. The second transistor T2 is turned on according to the first write scan signal SWj received through the first write scan line SWLj. In this case, the second transistor T2 may transmit the data signal Di provided from the data line DLi to the first electrode of the first transistor T1.

The third transistor T3 is connected between the second electrode of the first transistor T1 and a first node N1. The third transistor T3 includes a first electrode connected to the third electrode of the first transistor T1, a second electrode connected to the second electrode of the first transistor T1, and a third electrode connected to the compensation scan line SCLj. The third electrode of the third transistor T3 may be a gate electrode. The third transistor T3 is turned on according to the compensation scan signal SCj received through the compensation scan line SCLj to diode-connect the first transistor T1 by connecting the third electrode and the second electrode of the first transistor T1 to each other.

The fourth transistor T4 is connected between the second initialization line VL4 to which the second initialization voltage VINT2 is applied and the first node N1. The fourth transistor T4 includes a first electrode connected to the third electrode of the first transistor T1, a second electrode connected to the second initialization voltage line VL4 to which the second initialization voltage VINT2 is provided, and a third electrode connected to the initialization scan line SILj. The third electrode of the fourth transistor T4 may be a gate electrode. The fourth transistor T4 is turned on according to the initialization scan signal SIj received through the initialization scan line SILj. The turned-on fourth transistor T4 transmits the second initialization voltage VINT2 to the third electrode of the first transistor T1 to initialize the potential of the third electrode of the first transistor T1 (e.g., the potential of the first node N1).

The fifth transistor T5 includes a first electrode connected to the first driving voltage line VL1, a second electrode connected to the first electrode of the first transistor T1, and a third electrode connected to the emission control line EMLj. The third electrode of the fifth transistor T5 may be a gate electrode. The fifth transistor T5 may be referred to as a first emission control transistor.

The sixth transistor T6 includes a first electrode connected to the second electrode of the first transistor T1, a second electrode connected to the anode of the light emitting element ED, and a third electrode connected to the emission control line EMLj. The third electrode of the sixth transistor T6 may be a gate electrode. The sixth transistor T6 may be referred to as a second emission control transistor.

The fifth transistor T5 and the sixth transistor T6 are simultaneously turned on according to the emission control signal EMj provided through the emission control line EMLj. The first driving voltage ELVDD applied through the turned-on fifth transistor T5 may be compensated through the diode-connected first transistor T1 and then provided to the light emitting element ED.

The seventh transistor T7 includes a first electrode connected to the first initialization voltage line VL3 to which the first initialization voltage VINT1 is provided, a second electrode connected to the second electrode of the sixth transistor T6, and a third electrode connected to the second write scan line SWLj+1. The third electrode of the seventh transistor T7 may be a gate electrode. The first initialization voltage VINT1 may have a voltage level equal to or lower than that of the second initialization voltage VINT2. In an embodiment of the inventive concept, each of the first and second initialization voltages VINT1 and VINT2 may have a voltage of about −3.5V.

As described above, a first end of the capacitor Cst is connected to the third electrode of the first transistor T1, and a second end of the capacitor Cst is connected to the first driving voltage line VL1. The cathode of the light emitting element ED may be connected to the second driving voltage line VL2 providing the second driving voltage ELVSS. The second driving voltage ELVSS may have a lower voltage level than the first driving voltage ELVDD. In an embodiment of the inventive concept, the second driving voltage ELVSS may have a lower voltage level than the first and second initialization voltages VINT1 and VINT2.

When the high level initialization scan signal SIj is provided through the initialization scan line SILj, the fourth transistor T4 is turned on in response to the high level initialization scan signal SIj. The second initialization voltage VINT2 is provided to the third electrode of the first transistor T1 through the turned-on fourth transistor T4, and the first node N1 is initialized by the second initialization voltage VINT2. Accordingly, the high level section of the initialization scan signal SIj may be the initialization section of the pixel PXij.

Next, when the high level compensation scan signal SCj is supplied through the compensation scan line SCLj, the third transistor T3 is turned on. The first transistor T1 is diode-connected by the turned-on third transistor T3 and is biased in the forward direction. In addition, the second transistor T2 is turned on by the low level first write scan signal SWj. Then, the compensation voltage “Di-Vth” reduced by the threshold voltage Vth of the first transistor T1 from the data signal Di supplied from the data line DLi is applied to the third electrode of the first transistor T1. In other words, the potential of the third electrode of the first transistor T1 may be the compensation voltage “Di-Vth”.

The first driving voltage ELVDD and the compensation voltage “Di-Vth” are applied to both ends of the capacitor Cst, and a charge corresponding to a voltage difference between the both ends may be stored in the capacitor Cst. Here, the high-level section of the compensation scan signal SCj may be referred to as a compensation section of the pixel PXij.

The seventh transistor T7 is turned on by receiving the low-level second write scan signal SWj+1 through the second write scan line SWLj+1. A portion of the driving current Id may escape through the seventh transistor T7 as a bypass current Ibp by the seventh transistor T7.

The configuration of the pixel driving unit PDC according to an embodiment of the inventive concept is not limited to the embodiment shown in FIG. 3B. The pixel driving unit PDC illustrated in FIG. 3B is only an example, and the configuration of the pixel driving unit PDC may be modified.

FIG. 4A shows a unit pixel area UPX of the display panel DP-1a, and FIG. 4B is a cross-sectional view taken along line I-I′ of FIG. 4A.

Referring to FIG. 4A, a unit pixel area UPX may be provided in the display panel DP-1a. A plurality of unit pixel areas UPX may be provided. The unit pixel area UPX may include a first unit pixel area UPX1, a second unit pixel area UPX2, a third unit pixel area UPX3, and a fourth unit pixel area UPX4.

The arrangement of photovoltaic elements OPV and the pixels PXG and PXB disposed in the first unit pixel area UPX1 and the fourth unit pixel area UPX4 correspond to each other, and the arrangement of the photovoltaic elements OPV and pixels PXG and PXR disposed in the second unit pixel area UPX2 and the third unit pixel area UPX3 may correspond to each other. Accordingly, the description of the first unit pixel area UPX1 may be used for the description of the fourth unit pixel area UPX4. The description of the second unit pixel area UPX2 may be used for the description of the third unit pixel area UPX3.

Photovoltaic elements OPV, green pixels PXG, and blue pixels PXB may be disposed in the first unit pixel area UPX1. The photovoltaic elements OPV may be spaced apart from each other in an oblique direction in the first and second directions DR1 and DR2. The green pixel PXG may be spaced apart from the blue pixel PXB in an oblique direction in each of the first and second directions DR1 and DR2. A first photovoltaic element OPV may be spaced apart from the green pixel PXG in the second direction DR2 and may be spaced apart from the blue pixel PXB in the first direction DR1. A second photovoltaic element OPV may be spaced apart from the green pixel PXG in the first direction DR1 and may be spaced apart from the blue pixel PXB in the second direction DR2.

Photovoltaic elements OPV, green pixels PXG, and red pixels PXR may be disposed in the second unit pixel area UPX2. The photovoltaic elements OPV may be spaced apart from each other in an oblique direction in the first and second directions DR1 and DR2. The green pixels PXG may be spaced apart from the red pixels PXR in oblique directions in the first and second directions DR1 and DR2, respectively. A first photovoltaic element OPV may be spaced apart from the green pixel PXG in the second direction DR2 and may be spaced apart from the red pixel PXR in the first direction DR1. A second photovoltaic element OPV may be spaced apart from the green pixel PXG in the first direction DR1 and may be spaced apart from the red pixel PXR in the second direction DR2.

According to an embodiment, each of the red pixel PXR, green pixel PXG, and blue pixel PXB may have a square or rectangular shape. The size of each of the red pixel PXR, the green pixel PXG, and the blue pixel PXB may be different from each other. However, the embodiment of the inventive concept is not limited thereto, and each of the red pixel PXR, the green pixel PXG, and the blue pixel PXB may have any one of a diamond, a circle, and an ellipse shape. The shapes of the photovoltaic elements OPV may correspond to the pixels PXR, PXG, and PXB. Each of the photovoltaic elements OPV may have the same area as each other. However, the embodiment of the inventive concept is not limited thereto, and the area of each of the photovoltaic elements OPV may be different from each other.

Referring to FIG. 4B, a display device DD-1a according to an embodiment may include a display module DM-1a and a window WM. The display module DM-1a may include a display panel DP-1a, an input detection layer ISL, and a color filter layer CFL. The display panel DP-1a includes a base layer BL, a circuit layer DP_CL, a display element layer DP_ED, and an encapsulation layer TFE.

A description of the components included in the display panel DP-1a according to the present embodiment may correspond to the components included in the display panel DP-1 described with reference to FIG. 2A. The display element layer DP_ED according to an embodiment may include a pixel defining layer PDL, pixels PXR, PXG, and PXB, and photovoltaic elements OPV.

The display area DA of the display panel DP-1a may include emission areas PXA and a non-emission area NPXA adjacent to the emission areas PXA. The green pixel PXG may be disposed in the green emission area PXA. The blue pixel PXB may be disposed in the blue emission area PXA. The red pixel PXR may be disposed in the red emission area PXA.

The emission areas PXA may be areas providing light generated by the pixels PXR, PXG, and PXB. A non-emission area NPXA may be an area in which no light is generated. The non-emission area NPXA may include cell areas OPA and light blocking areas BMA.

The photovoltaic elements OPV according to the present embodiment may be disposed in the non-emission area NPXA. The photovoltaic elements OPV may be disposed in the cell areas OPA of the non-emission area NPXA.

In the pixel defining layer PDL according to the present embodiment, first openings OPP1 corresponding to emission areas PXA and second openings OPP2 corresponding to cell areas OPA in the non-emission areas NPXA may be formed.

The first openings OPP1 and the second openings OPP2 may be formed by penetrating the pixel defining layer PDL. An area overlapping the pixel defining layer PDL within the non-emission area NPXA may be a light blocking area BMA.

The pixel defining layer PDL may be formed of a polymer resin. For example, the pixel defining layer PDL may be formed of a polyacrylate-based resin or a polyimide-based resin. In addition, the pixel defining layer PDL may be formed by further including an inorganic material in addition to the polymer resin. The pixel defining layer PDL may be formed by including a light absorbing material, or may be formed by including a black pigment or a black dye. A pixel defining layer PDL formed including a black pigment or black dye may implement a black pixel defining layer. When forming the pixel defining layer PDL, carbon black or the like may be used as a black pigment or black dye, but embodiments are not limited thereto.

The green pixel PXG may include a first pixel driving unit PDC1 and a green light emitting element ED-G included in the circuit layer DP_CL. The blue pixel PXB may include a second pixel driving unit PDC2 and a blue light emitting element ED-B. Correspondingly, the red pixel PXR may include a third pixel driving unit and a red light emitting element. Hereinafter, descriptions of the green pixel PXG and the blue pixel PXB may be applied to the red pixel PXR.

The green light emitting element ED-G may include a first electrode AE-G connected to the first pixel driving unit PDC1, a second electrode CE, and a light emitting layer EML-G. The light emitting layer EML-G may be disposed between the first electrode AE-G and the second electrode CE. The light emitting layer EML-G may include an organic light emitting material or a quantum dot material.

In addition, the green light emitting element ED-G may include a hole control layer HTR, and an electron control layer ETR. The hole control layer HTR may be disposed between the first electrode AE-G and the light emitting layer EML-G, and the electron control layer ETR may be disposed between the light emitting layer EML-G and the second electrode CE. An uppermost width of the first opening OPP1 may correspond to an uppermost width of the light emitting layer EML-G in the green pixel PXG.

The blue light emitting element ED-B may include a first electrode AE-B connected to the second pixel driving unit PDC2, a second electrode CE, and a light emitting layer EML-B. The light emitting layer EML-B may be disposed between the first electrode AE-B and the second electrode CE. The light emitting layer EML-B may include an organic light emitting material or a quantum dot material.

In addition, the blue light emitting element ED-B may include a hole control layer HTR and an electron control layer ETR. The hole control layer HTR may be disposed between the first electrode AE-B and the light emitting layer EML-B, and the electron control layer ETR may be disposed between the light emitting layer EML-B and the second electrode CE. An uppermost width of the first opening OPP1 may correspond to an uppermost width of the light emitting layer EML-B in the blue pixel PXB.

According to this embodiment, at least a portion of each of the first electrodes AE-G and AE-B may be exposed by a corresponding first opening OPP1 among the first openings OPP1. The light emitting layers EML-G and EML-B may be disposed in a corresponding first opening OPP1 among the first openings OPP1.

At least one of the hole control layer HTR, the electron control layer ETR, and the second electrode CE included in the plurality of pixels PXG, PXB, and PXR is provided as a common layer and has an integral shape. FIG. 4B shows that the electron control layer ETR and the second electrode CE are provided as a common layer and have an integral shape, and the hole control layer HTR may also be provided in an integral shape, and is not limited to any one embodiment.

The display element layer DP_ED of the display panel DP-1a according to the present embodiment may include photovoltaic elements OPV. The photovoltaic elements OPV may be disposed in the cell areas OPA of the non-emission area NPXA.

Each of the photovoltaic elements OPV may include a first electrode AE (first cell electrode), a second electrode CE (second cell electrode), and an optical photovoltaic layer PVL. At least a portion of the first electrodes AE may be exposed by a corresponding second opening OPP2 among the second openings OPP2. The optical photovoltaic layer PVL may be disposed in a corresponding second opening OPP2 among the second openings OPP2. An uppermost width of the second opening OPP2 may correspond to an uppermost width of the optical photovoltaic layer PVL.

In the display element layer DP_ED, the first electrodes AE-G, AE-B, and AE may be disposed on the same layer. The first electrodes AE-G, AE-B, and AE may be formed of a metal material, a metal alloy, or a conductive compound. The first electrodes AE-G, AE-B, and AE may be an anode or a cathode. However, the embodiment is not limited thereto. In addition, the first electrodes AE-G, AE-B, and AE may be a pixel electrode or a detection electrode. The first electrodes AE-G, AE-B, and AE may be transmissive electrodes, semi-transmissive electrodes, or reflective electrodes. When the first electrodes AE-G, AE-B, and AE are transmissive electrodes, the first electrodes AE-G, AE-B, and AE may include a transparent metal oxide, for example, indium tin oxide (ITO), indium zinc oxide (IZO), zinc oxide (ZnO), indium tin zinc oxide (ITZO), and the like.

When the first electrodes AE-G, AE-B, and AE are a semi-transmissive electrode or a reflective electrode, the first electrodes AE-G, AE-B, and AE may include Ag, Mg, Cu, Al, Pt, Pd, Au, Ni, Nd, Ir, Cr, Li, Ca, LiF/Ca, LiF/Al, Mo, Ti, W or a compound thereof or mixtures (e.g., a mixture of Ag and Mg).

The second electrode CE may be a common electrode. The second electrode CE may be a cathode or an anode, but the embodiment is not limited thereto. For example, when the first electrodes AE-G, AE-B, and AE are an anode, the second electrode CE may be a cathode, and when the first electrodes AE-G, AE-B, and AE are a cathode, the second electrode CE may be an anode.

The second electrode CE may be a transmissive electrode, a semi-transmissive electrode, or a reflective electrode. When the second electrode CE is a transmissive electrode, it may be formed of a transparent metal oxide, for example, indium tin oxide (ITO), indium zinc oxide (IZO), zinc oxide (ZnO), or indium tin zinc oxide (ITZO). When the second electrode CE is a semi-transmissive electrode or a reflective electrode, it may include Ag, Mg, Cu, Al, Pt, Pd, Au, Ni, Nd, Ir, Cr, Li, Ca, LiF/Ca, LiF/Al, Mo, Ti, Yb, W, or a compound or mixture (e.g., AgMg, AgYb, or MgAg) including these.

Each of the photovoltaic elements OPV may be disposed between the first electrode AE and the second electrode CE and include an optical photo voltaic layer PVL. The optical photovoltaic layer PVL may be disposed in a corresponding second opening OPP2 among the second openings OPP2. The optical photo voltaic layer PVL may include a battery material that receives light and converts it into electrical energy. In one embodiment, the optical photo voltaic layer PVL may include a crystalline silicon-based (C-SI) material. However, the embodiment is not limited thereto.

Each of the photovoltaic elements OPV according to an embodiment may include a hole control layer HTR and an electron control layer ETR. The hole control layer HTR may be disposed between the first electrode AE and the optical photo voltaic layer PVL, and the electron control layer ETR may be disposed between the optical photovoltaic layer PVL and the second electrode CE. The photovoltaic layer may be in direct contact with each of the hole control layer HTR and the electron control layer ETR.

In an embodiment, the hole control layer HTR constituting the light emitting elements ED-G and ED-B and the photovoltaic elements OPV may have a single layer made of a single material, a single layer made of a plurality of different materials, or a multilayer structure having a plurality of layers made of a plurality of different materials. For example, the hole control layer HTR may have a structure of a hole injection layer or a single layer of a hole transport material, or may have a structure of a single layer including a hole injection material and a hole transport material.

In an embodiment, the hole control layer HTR included in the light emitting elements ED-R, ED-G, and ED-B and the photovoltaic element OPV includes a hole transport layer, and may further include a hole injection layer.

In addition, in an embodiment, the electron control layer ETR constituting the light emitting elements ED-G and ED-B and the photovoltaic elements OPV may have a single layer made of a single material, a single layer made of a plurality of different materials, or a multilayer structure having a plurality of layers made of a plurality of different materials.

For example, the electron control layer ETR may have a single-layer structure of an electron injection layer or an electron transport layer, or may have a single-layer structure including an electron injection material and an electron transport material. In addition, the electron control layer ETR may have a structure of a single layer made of a plurality of different materials or may further include a plurality of layers sequentially stacked.

The second electrode CE of the light emitting elements ED-G and ED-B and the photovoltaic elements OPV may be provided as a common layer. Accordingly, the light emitting elements ED-G and ED-B and the photovoltaic elements OPV may have an integral shape.

Since the photovoltaic elements OPV are disposed within the display area DA, they may receive photovoltaic light incident on the display area DA to generate a photoelectric phenomenon. For example, light energy of the photovoltaic light incident on the display area DA is converted into electrical energy by the photovoltaic elements OPV, and the converted electrical energy may supply electrical energy to a power supply module (e.g., a battery). Since the display device DD-1a according to an embodiment of the inventive concept includes an additional energy source by virtue of the photovoltaic elements OPV, the display device DD-1a with improved power consumption may be provided. The display panel DP-1a according to an embodiment may further include a capacitor that stores electrical energy converted by the photovoltaic elements OPV.

The display element layer DP_ED according to an embodiment may further include a protection layer CPL. The protection layer CPL may be disposed on the second electrode CE, which is a common layer, to directly cover the second electrode CE. The protection layer CPL protects the second electrode CE in a subsequent process. The protection layer CPL may include organic materials.

The encapsulation layer TFE is disposed on the display element layer DP_ED and is commonly disposed in the light emitting elements ED-G and ED-B and the photovoltaic elements OPV. The encapsulation layer TFE may include a plurality of insulating layers. The encapsulation layer TFE protects light emitting elements ED-G and ED-B and photovoltaic elements OPV from moisture and foreign matter.

The input detection layer ISL may be directly disposed on the encapsulation layer TFE. The input detection layer ISL may include a plurality of detection electrodes and at least one detection insulating layer. The input detection layer ISL may detect external input.

The color filter layer CFL may be disposed on the display element layer DP_ED. The color filter layer CFL may include color filters CF-G and CF-B and a light blocking layer BM. The color filters CF-G and CF-B may include a red color filter, a green color filter CF-G, and a blue color filter CF-B. The red color filter, the green color filter CF-G, and the blue color filter CF-B may overlap the red emission area PXA, the green emission area PXA, and the blue emission area PXA, respectively.

The green color filter CF-G may overlap the green light emitting element ED-G and one photovoltaic element OPV. The blue color filter CF-B may overlap the blue light emitting element ED-B and the other photovoltaic element OPV.

The color filters CF-G and CF-B may transmit red light, green light, and blue light. The color filters CF-G and CF-B may include polymer photoresists and pigments or dyes.

The light blocking layer BM may be disposed on the display element layer DP_ED. A plurality of light blocking openings BM-OP corresponding to the emission areas PXA in a one-to-one manner may be formed in the light blocking layer BM. The light blocking layer BM may be covered by the color filters CF-G and CF-B. For example, the plurality of light blocking openings BM-OP may be covered by the color filters CF-G and CF-B. The light blocking layer BM may overlap light blocking areas BMA.

The light blocking layer BM may be disposed on the input detection layer ISL and overlap the boundaries of the neighboring color filters CF-G and CF-B. The light blocking layer BM may prevent light leakage and distinguish boundaries between adjacent color filters CF-G and CF-B.

The light blocking layer BM may be a black matrix. The light blocking layer BM may include an organic pigment or dye. The light blocking layer BM may include an organic light blocking material or an inorganic light blocking material including a black pigment or black dye. The light blocking layer BM may be formed from a light blocking composition including propylene glycol monomethyl ether acetate, 3-methoxybutyl acetate, and an organic black pigment. In addition, the light blocking layer BM may overlap the pixel defining layer PDL.

The window WM may be disposed on the color filter layer CFL. A separate adhesive layer may be disposed between the window WM and the color filter layer CFL to couple them to each other. The adhesive layer may include any one of an optically clear adhesive, an optically clear adhesive resin, and a pressure sensitive adhesive (PSA).

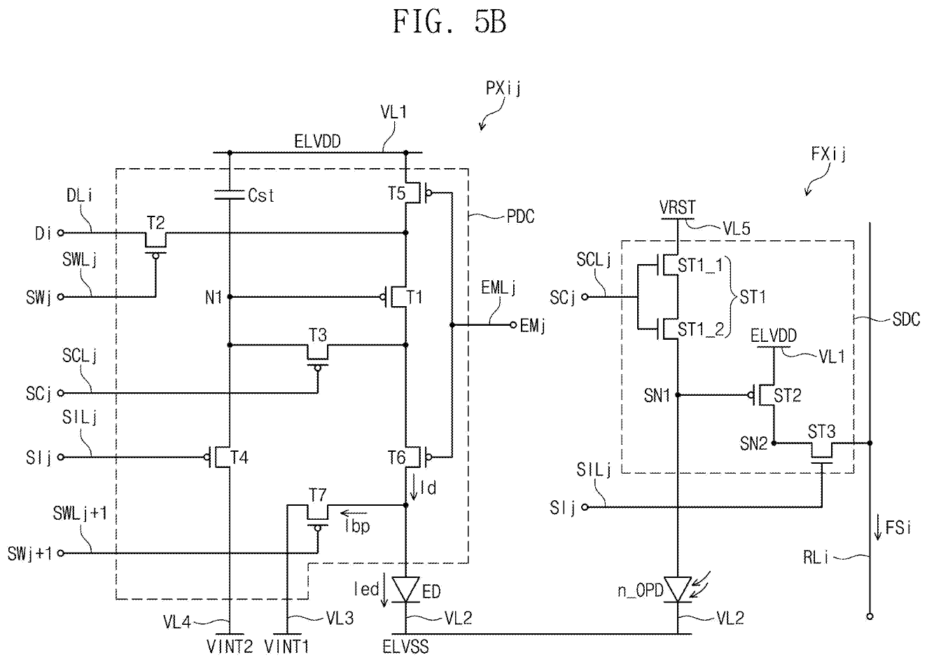

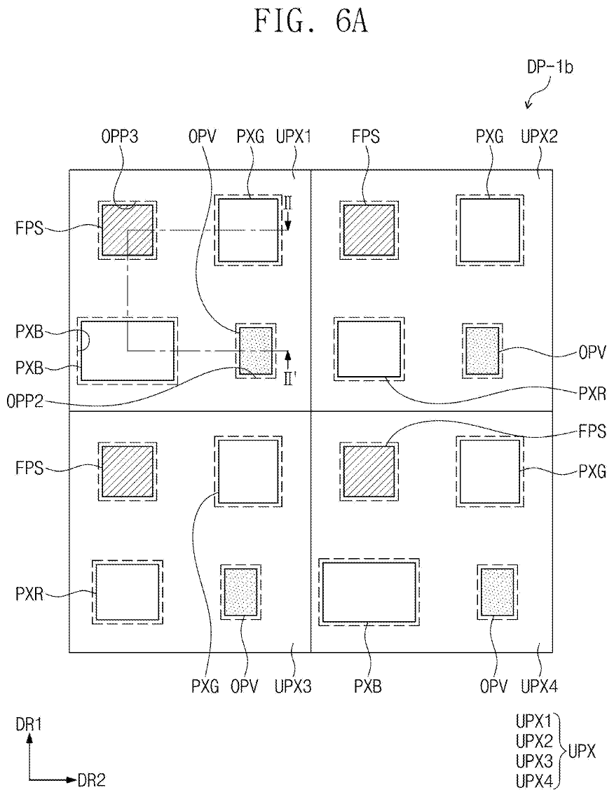

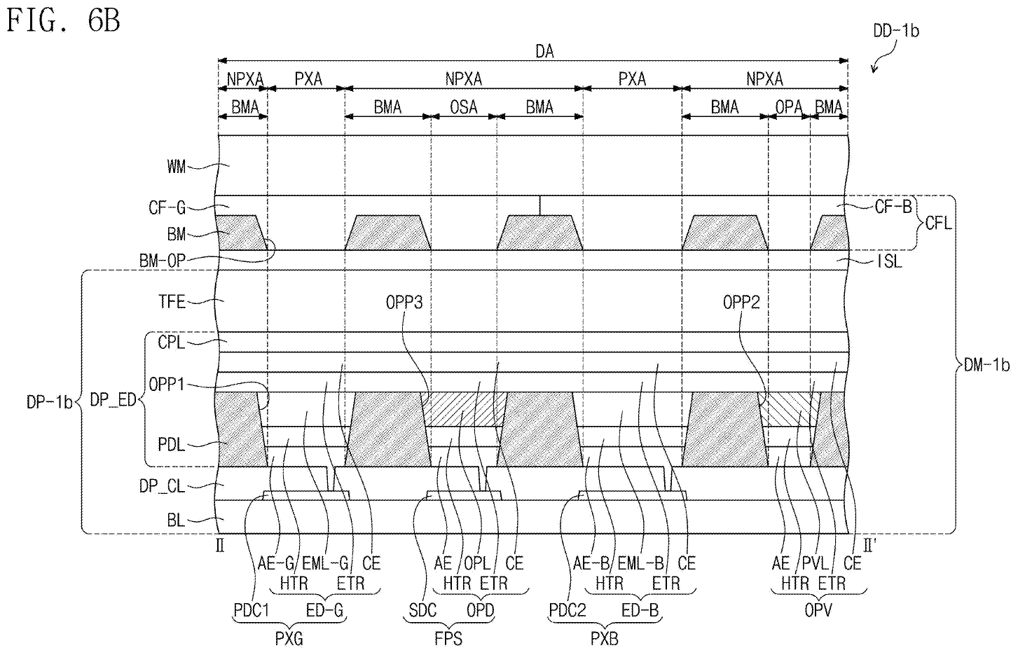

FIG. 5A is a block diagram of a display device according to an embodiment of the inventive concept. FIG. 5B is an equivalent circuit diagram of a pixel and a sensor according to an embodiment of the inventive concept. FIG. 6A is a plan view illustrating a display device according to an embodiment of the inventive concept. FIG. 6B is a cross-sectional view of a display device according to an embodiment of the inventive concept. The stacked structure of the display device DD-1b described with reference to FIGS. 5A to 6B may correspond to the stacked structure of the display device DD-1 described with reference to FIG. 2A. The same/similar reference numerals are used for the same/similar configurations as those described with reference to FIGS. 1A to 4B, and redundant descriptions are omitted.

Referring to FIG. 5A, a display device DD-1b according to an embodiment includes a display panel DP-1b, a panel driver, and a driving controller 100. In an embodiment of the inventive concept, the panel driver may include a data driver 200, a scan driver 300, an emission driver 350, and a voltage generator 400. The display device DD-1b according to an embodiment further includes a readout circuit 500.

The data driver 200, the scan driver 300, the emission driver 350, and the voltage generator 400 may correspond to the data driver 200, the scan driver 300, the emission driver 350, and the voltage generator 400 described with reference to FIG. 3A.

The display panel DP-1b according to an embodiment may include a plurality of pixels PX disposed in the display area DA and a plurality of sensors FX disposed in the display area DA. In an embodiment of the inventive concept, each of the plurality of sensors FX may be disposed between two pixels PX adjacent to each other. The plurality of pixels PX and the plurality of sensors FX may be alternately disposed in the first and second directions DR1 and DR2.

The plurality of sensors FX are electrically connected to the initialization scan lines SIL1 to SILn, the compensation scan lines SCL1 to SCLn, and readout lines RL1 to RLm, respectively. Each of the plurality of sensors FX may be electrically connected to two scan lines. For example, as shown in FIG. 3, the sensors FX in the first row may be connected to the first initialization scan line SIL1 and the first compensation scan line SCL1. In addition, the sensors FX in the second row may be connected to the second initialization scan line SIL2 and the second compensation scan line SCL2.

The readout circuit 500 receives a control signal RCS from the driving controller 100. The readout circuit 500 may receive detection signals from the readout lines RL1 to RLm in response to the control signal RCS. The readout circuit 500 may process detection signals received from the readout lines RL1 to RLm and provide the processed detection signals S_FS to the driving controller 100. The driving controller 100 may recognize biometric information based on the detection signals S_FS.

FIG. 5B shows an equivalent circuit diagram of a pixel PXij among the plurality of pixels PX and an equivalent circuit diagram of a sensor FXij among the plurality of sensors FX. An equivalent circuit diagram of the pixel PXij may correspond to the equivalent circuit diagram described with reference to FIG. 3B.

Referring to FIG. 5B, the sensor FXij is connected to an i-th readout line RLi (hereinafter referred to as a readout line) among the readout lines RL1 to RLm, an initialization scan line SILj, and a compensation scan line SCLj. The sensor FXij may be further connected to the first and second driving voltage lines VL1 and VL2 and a reset voltage line VL5.

The sensor FXij includes a light detection element OPD (see FIG. 6B) and a sensor driving unit SDC. In an embodiment, the sensor FXij may include a plurality of light detection elements n_OPD and one sensor driving unit SDC. For example, n light detection elements n_OPD may be connected to one sensor driving unit SDC. The light detection element OPD may be a photodiode. In an embodiment of the inventive concept, the light detection element OPD may be an organic photodiode including an organic material as a photoelectric conversion layer. The anode of the light detection element OPD may be connected to a first sensing node SN1, and the cathode of the light detection element OPD may be connected to the second driving voltage line VL2 providing the second driving voltage ELVSS.

The sensor driving unit SDC includes three transistors ST1, ST2, and ST3. The three transistors ST1, ST2, and ST3 may be a reset transistor ST1, an amplification transistor ST2, and an output transistor ST3, respectively. Some of the reset transistor ST1, the amplification transistor ST2, and the output transistor ST3 may be P-type transistors, and some of the reset transistor ST1, the amplification transistor ST2, and the output transistor ST3 may be N-type transistors. In an embodiment of the inventive concept, the amplification transistor ST2 may be a PMOS transistor, and the reset transistor ST1 and the output transistor ST3 may be NMOS transistors. However, the embodiment of the inventive concept is not limited thereto, and all of the reset transistor ST1, the amplification transistor ST2, and the output transistor ST3 may be N-type transistors or P-type transistors.

Some (e.g., the reset transistor ST1 and the output transistor ST3) of the reset transistor ST1, the amplification transistor ST2, and the output transistor ST3 may be the same type of transistor as the third and fourth transistors T3 and T4 of the pixel PXij. Some (e.g., the amplification transistor ST2) of the reset transistor ST1, the amplification transistor ST2, and the output transistor ST3 may be the same type of transistors as the first and second transistors T1 and T2 of the pixel PXij.

The circuit configuration of the sensor driving unit SDC according to the inventive concept is not limited to FIG. 5B. The sensor driving unit SDC illustrated in FIG. 5B is only an example, and the configuration of the sensor driving unit SDC may be modified.

The reset transistor ST1 includes a first electrode connected to the reset voltage line VL5 for receiving a reset voltage VRST, a second electrode connected to the first sensing node SN1, and a third electrode connected to the compensation scan line SCLj for receiving the compensation scan signal SCj. The reset transistor ST1 may reset the potential of the first sensing node SN1 to the reset voltage VRST in response to the compensation scan signal SCj. In an embodiment of the inventive concept, the reset voltage VRST may have a voltage level corresponding to an activation section (e.g., a low-level section) of the first and second write scan signals SWj and SWj+1. The reset voltage VRST may have a lower voltage level than the second driving voltage ELVSS.

The reset transistor ST1 may include a plurality of sub-reset transistors connected in series between the reset voltage line VL5 and the first sensing node SN1. In an embodiment of the inventive concept, the reset transistor ST1 includes a first sub-reset transistor ST1_1 and a second sub-reset transistor ST1_2. The third electrode of the first sub-reset transistor ST1_1 and the third electrode of the second sub-reset transistor ST1_2 are connected to the compensation scan line SCLj. In addition, the second electrode of the first sub-reset transistor ST1_1 and the first electrode of the second sub-reset transistor ST1_2 may be electrically connected to each other. In addition, a first electrode of the first sub-reset transistor ST1_1 may be connected to the reset voltage line VL5, and a second electrode of the second sub-reset transistor ST1_2 may be electrically connected to the first sensing node SN1. However, the number of sub-reset transistors is not limited thereto, and may be variously modified.

The amplification transistor ST2 includes a first electrode connected to the first driving voltage line VL1 receiving the first driving voltage ELVDD, a second electrode connected to a second sensing node SN2, and a third electrode connected to the first sensing node SN1. The amplification transistor ST2 may be turned on according to the potential of the first sensing node SN1 to apply the first driving voltage ELVDD to the second sensing node SN2.

The output transistor ST3 includes a first electrode connected to the second sensing node SN2, a second electrode connected to the readout line RLi, and a third electrode connected to the initialization scan line SILj for receiving the initialization scan signal SIj. The output transistor ST3 may transmit the detection signal FSi to the readout line RLi in response to the initialization scan signal SIj.

The display panel DP-1b includes the pixel PXij and the sensor FXij, and the sensor FXij may be driven using the initialization scan signal SIj and the compensation scan signal SCj for driving the pixel PXij. In particular, the initialization scan signal SIj and the compensation scan signal SCj supplied to the third and fourth transistors T3 and T4 of the pixel PXij may be supplied to the reset transistor ST1 and the output transistor ST3 of the sensor FXij. Accordingly, since a separate signal line or circuit required to drive the sensor FXij is unnecessary, even when the sensor FXij is disposed on the display panel DP-1b, a reduction in the aperture ratio may be minimized or prevented.

FIG. 6A shows a unit pixel area UPX of the display panel DP-1b, and FIG. 6B is a cross-sectional view taken along line II-II′ of FIG. 6A.

Referring to FIG. 6A, the unit pixel area UPX may be provided in the display panel DP-1b. A plurality of unit pixel areas UPX may be provided. The unit pixel area UPX may include a first unit pixel area UPX1, a second unit pixel area UPX2, a third unit pixel area UPX3, and a fourth unit pixel area UPX4.

The arrangement of optical sensor FPS, the photovoltaic element OPV, and the pixels PXG and PXB disposed in the first unit pixel area UPX1 and the fourth unit pixel area UPX4 may correspond to each other, and the arrangement of the optical sensor FPS, the photovoltaic element OPV, and the pixels PXG and PXR disposed in the second unit pixel area UPX2 and the third unit pixel area UPX3 may correspond to each other. Accordingly, the description of the first unit pixel area UPX1 corresponds to the description of the fourth unit pixel area UPX4. The description of the second unit pixel area UPX2 corresponds to the description of the third unit pixel area UPX3.

An optical sensor FPS, a photovoltaic element OPV, a green pixel PXG, and a blue pixel PXB may be disposed in the first unit pixel area UPX1. The optical sensor FPS and the photovoltaic element OPV may be spaced apart from each other in oblique directions in the first and second directions DR1 and DR2. The green pixel PXG may be spaced apart from the blue pixel PXB in an oblique direction in each of the first and second directions DR1 and DR2. The optical sensor FPS may be spaced apart from the green pixel PXG in the second direction DR2 and may be spaced apart from the blue pixel PXB in the first direction DR1. The photovoltaic element OPV may be spaced apart from the green pixel PXG in the first direction DR1 and may be spaced apart from the blue pixel PXB in the second direction DR2.

An optical sensor FPS, a photovoltaic element OPV, a green pixel PXG, and a red pixel PXR may be disposed in the second unit pixel area UPX2. The optical sensor FPS and the photovoltaic element OPV may be spaced apart from each other in oblique directions in the first and second directions DR1 and DR2. The green pixel PXG may be spaced apart from the red pixel PXR in oblique directions of the first and second directions DR1 and DR2, respectively. The optical sensor FPS may be spaced apart from the green pixel PXG in the second direction DR2 and may be spaced apart from the red pixel PXR in the first direction DR1. The photovoltaic element OPV may be spaced apart from the green pixel PXG in the first direction DR1 and may be spaced apart from the red pixel PXR in the second direction DR2.

According to an embodiment, the area of the optical sensor FPS and the area of the photovoltaic element OPV may be different from each other. For example, an area of an optical sensor FPS may be larger than an area of a photovoltaic element OPV. However, the embodiment of the inventive concept is not limited thereto, and the area of the photovoltaic element OPV may be equal to or greater than the area of the optical sensor FS.

Referring to FIG. 6B, a display device DD-1b according to an embodiment may include a display module DM-1b and a window WM. The display module DM-1b may include a display panel DP-1b, an input detection layer ISL, and a color filter layer CFL. The display panel DP-1b includes a base layer BL, a circuit layer DP_CL, a display element layer DP_ED, and an encapsulation layer TFE.

A description of the components included in the display panel DP-1b according to the present embodiment may correspond to the components included in the display panels DP-1 and DP-1a described with reference to FIGS. 2A and 4B. A display element layer DP_ED according to an embodiment may include a pixel defining layer PDL, pixels PXR, PXG, and PXB, optical sensors FPS, and photovoltaic elements OPV.

The display area DA of the display panel DP-1b may include emission areas PXA and a non-emission area NPXA adjacent to the emission areas PXA. The green pixel PXG may be disposed in the green emission area PXA. The blue pixel PXB may be disposed in the blue emission area PXA. The red pixel PXR may be disposed in the red emission area PXA.

Optical sensors FPS and photovoltaic elements OPV according to this embodiment may be disposed in a non-emission area NPXA. The photovoltaic elements OPV may be disposed in the cell areas OPA of the non-emission area NPXA, and the optical sensors FPS may be disposed in the sensing areas OSA of the non-emission area NPXA.

In the pixel defining layer PDL according to the present embodiment, first openings OPP1 corresponding to emission areas PXA and second openings OPP2 corresponding to cell areas OPA in the non-emission areas NPXA may be formed. In addition, third openings OPP3 corresponding to the sensing areas OSA of the non-emission area NPXA may be formed in the pixel defining layer PDL.

The first openings OPP1, the second openings OPP2, and the third openings OPP3 may be formed by penetrating the pixel defining layer PDL. An area overlapping a pixel defining layer PDL within a non-emission area NPXA may be a light blocking area BMA.

Each of the pixels PXG and PXB may include pixel driving units PDC1 and PDC2 and light emitting elements ED-G and ED-B. The light emitting elements ED-G and ED-B may include first electrodes AE-G and AE-B connected to the pixel driving units PDC1 and PDC2, a second electrode CE, and light emitting layers EML-G and EML-B.

In addition, the light emitting elements ED-G and ED-B may further include a hole control layer HTR disposed between the first electrodes AE-G and AE-B and the light emitting layers EML-G and EML-B and an electron control layer ETR disposed between the light emitting layers EML-G and EML-B and the second electrode CE. At least one of the hole control layer HTR, the electron control layer ETR, and the second electrode CE is provided as a common layer and may have an integral shape.

According to this embodiment, at least a portion of each of the first electrodes AE-G and AE-B may be exposed by a corresponding first opening OPP1 among the first openings OPP1. The light emitting layers EML-G and EML-B may be disposed in a corresponding first opening OPP1 among the first openings OPP1.

Each of the photovoltaic elements OPV may include a first electrode AE (first cell electrode), a second electrode CE (second cell electrode), and an optical photovoltaic layer PVL. At least a portion of the first electrodes AE may be exposed by a corresponding second opening OPP2 among the second openings OPP2. The optical photovoltaic layer PVL may be disposed in a corresponding second opening OPP2 among the second openings OPP2.

Each of the optical sensors FS according to an embodiment may include a light detection element OPD and a sensor driving unit SDC. The sensor driving unit SDC may correspond to the sensor driving unit SDC described with reference to FIG. 5B.

One light detection element OPD may be electrically connected to one sensor driving unit SDC. The light detection element OPD may include an organic photodiode. According to an embodiment, two or more (n) light detection elements OPD may be connected to one sensor driving unit SDC.

Each of the light detection elements OPD may include a first electrode AE (or first sensor electrode), a second electrode CE (or second sensor electrode), and a light receiving layer OPL. At least a portion of each of the first electrodes AE may be exposed by a corresponding third opening OPP3 among the third openings OPP3. Each of the light receiving layers OPL may be disposed in a corresponding third opening OPP3 among the third openings OPP3. An uppermost surface of the light receiving layer OPL may be at the same level as an uppermost surface of an adjacent portion of the pixel defining layer PDL.

Each of the light detection elements OPD may include a hole control layer HTR and an electron control layer ETR. The hole control layer HTR may be disposed between the first electrode AE and the light receiving layer OPL, and the electron control layer ETR may be disposed between the light receiving layer OPL and the second electrode CE. The light receiving layer OPL may be in direct contact with each of the hole control layer HTR and the electron control layer ETR. At least one of the hole control layer HTR, the electron control layer ETR, and the second electrode CE is provided as a common layer and may have an integral shape.

The light receiving layer OPL may include a light receiving material that receives light and converts the received light into an electrical signal. For example, in an embodiment, the light receiving layer OPL may include an organic light receiving material. In an embodiment, the light receiving layer OPL may include an organic polymer material as a light receiving material, and for example, the light receiving layer OPL may include a conjugated polymer. The light receiving layer OPL may include a thiophene-based conjugated polymer, benzodithiophene-based conjugated polymer, thieno[3,4-c]pyrrole-4,6-dione (TPD)-based conjugated polymer, diketo-pyrrole-pyrrole (DPP))-based conjugated polymer, benzothiadiazole (BT)-based conjugated polymer, and the like. However, the embodiment is not limited thereto.

Since the display panel DP-1b according to the present embodiment includes photovoltaic elements OPV disposed in the display area DA and spaced apart from the pixels PXG and PXB, the display device DD-1b has improved power consumption. In addition, since the display panel DP-1b includes optical sensors FS disposed in the display area DA and spaced apart from the pixels PXG and PXB and the photovoltaic elements OPV, it is possible to detect the user's biometric information applied from the outside.

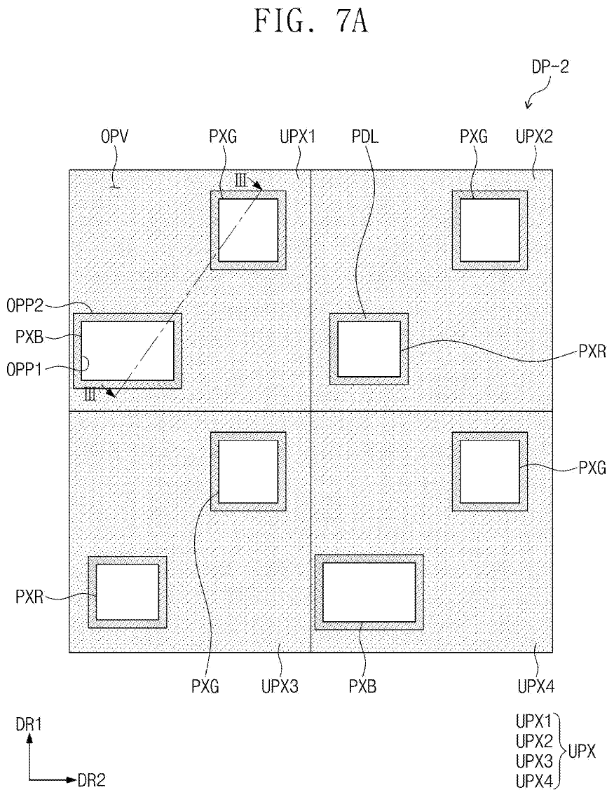

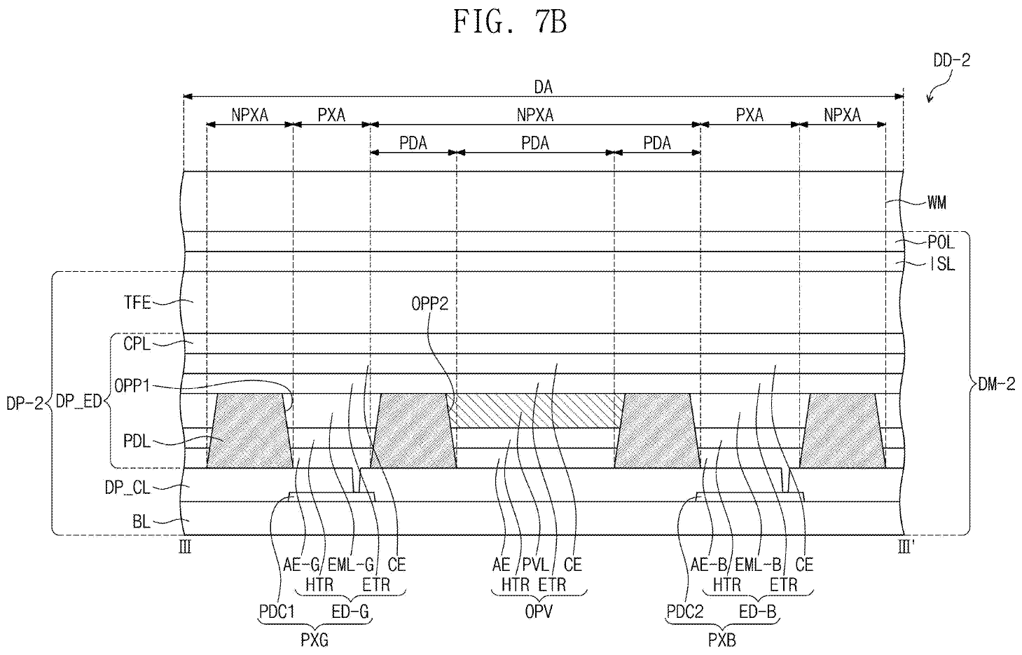

FIG. 7A is a plan view illustrating a display device according to an embodiment of the inventive concept. FIG. 7B is a cross-sectional view of a display device according to an embodiment of the inventive concept. The stacked structure of the display device DD-2 described with reference to FIGS. 7A and 7B may correspond to the stacked structure of the display device DD-2 described with reference to FIG. 2B. The same/similar reference numerals are used for the same/similar configurations as those described with reference to FIGS. 1A to 6B, and redundant descriptions are omitted.

Referring to FIGS. 7A and 7B, a display device DD-2 according to an embodiment may include a display module DM-2 and a window WM. The display module DM-2 may include a display panel DP-2, an input detection layer ISL, and an optical member POL. The display panel DP-2 includes a base layer BL, a circuit layer DP_CL, a display element layer DP_ED, and an encapsulation layer TFE. Description of the window WM, the display panel DP-2, and the input detection layer ISL may correspond to the window WM, the display panel DP-1, and the input detection layer ISL described with reference to FIG. 1A.

The optical member POL according to the present embodiment may be disposed on the input detection layer ISL. For example, the optical member POL may be in direct contact with the input detection layer ISL. The optical member POL may include at least one of an antireflection film, a polarizing film, and a gray filter for reducing reflectance of external light. The polarizing film may include a retarder and/or a polarizer.

In the display module DM-2 in which the optical member POL is disposed on the display panel DP-2, the amount of sunlight incident to the transmission area TA of the window WM may be greater than that of the display modules DM-1a and DM-1b in which the color filter layer CFL is disposed on the display panels DP-1a and DP-1B described with reference to FIGS. 4B and 6B.

A unit pixel area UPX may be formed in the display panel DP-2 according to the present embodiment. A plurality of unit pixel areas UPX may be provided. The unit pixel area UPX may include a first unit pixel area UPX1, a second unit pixel area UPX2, a third unit pixel area UPX3, and a fourth unit pixel area UPX4.

According to this embodiment, green pixels PXG and blue pixels PXB spaced apart from each other are disposed in the first and fourth unit pixel areas UPX1 and UPX4, and green pixels PXG and red pixels PXR spaced apart from each other may be disposed in the second and third unit pixel areas UPX2 and UPX3. In addition, an overlapping photovoltaic element OPV may be disposed on the entire non-emission area PXA of a unit pixel area UPX. For example, in the first unit pixel UPX1, the overlapping photovoltaic element OPV may cover all of the first unit pixel UPX1 except for the green pixel PXG and the blue pixel PXB.

A pixel-defining film PDL according to the inventive concept may include closed line-shaped patterns surrounding the pixels PXG, PXB, and PXR. First openings OPP1 exposing at least a portion of the first electrodes AE-G and AE-B included in each of the pixels PXG, PXB, and PXR, and a second opening OPP2 overlapping the non-emission area NPXA may be formed in the pixel defining layer PDL.

In this embodiment, the photovoltaic element OPV may include a first electrode AE (or first cell electrode), a second electrode CE (or second cell electrode), and an optical photovoltaic layer PVL. At least a portion of the first electrode AE may be exposed by the second opening OPP2. An optical photo voltaic layer PVL may be disposed on the second opening OPP2.

The photovoltaic element OPV according to an embodiment may include a hole control layer HTR and an electron control layer ETR. The hole control layer HTR may be disposed between the first electrode AE and the optical photovoltaic layer PVL, and the electron control layer ETR may be disposed between the optical photovoltaic layer PVL and the second electrode CE.

In the display panel DP-2 according to the present embodiment, since the optical member POL is placed on the input detection layer ISL, the amount of sunlight incident on the transmission area TA (see FIG. 2B) of the window WM may be greater than that of the display panels DP-1a and DP-1b on which the color filter layers CFL (see FIGS. 4B and 6B) are disposed. In addition, since the optical photo voltaic layer PVL is disposed in the entire area corresponding to the non-emission area PXA except for the pixel defining layer PDL, the amount of light energy converted into electrical energy may be increased. Accordingly, the display device DD-2 with improved power consumption may be provided.

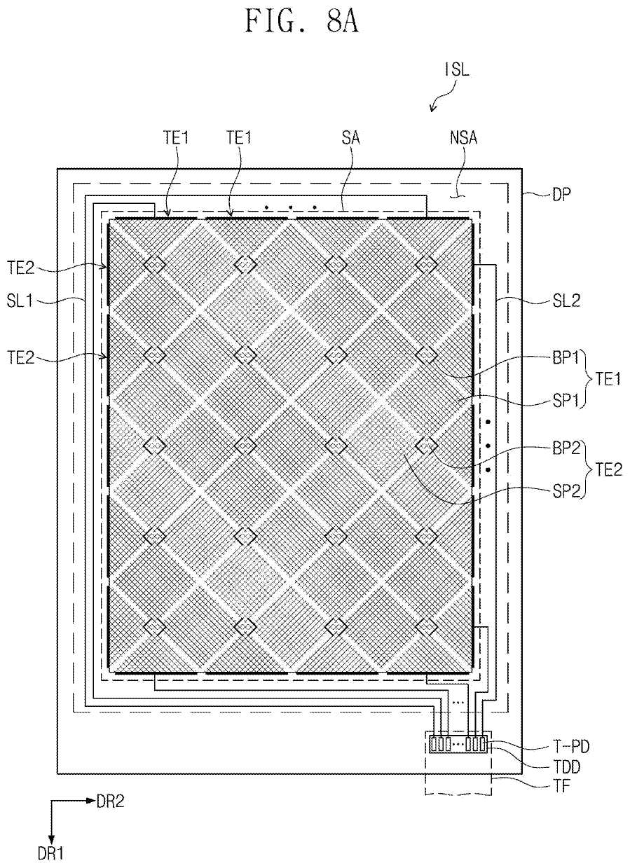

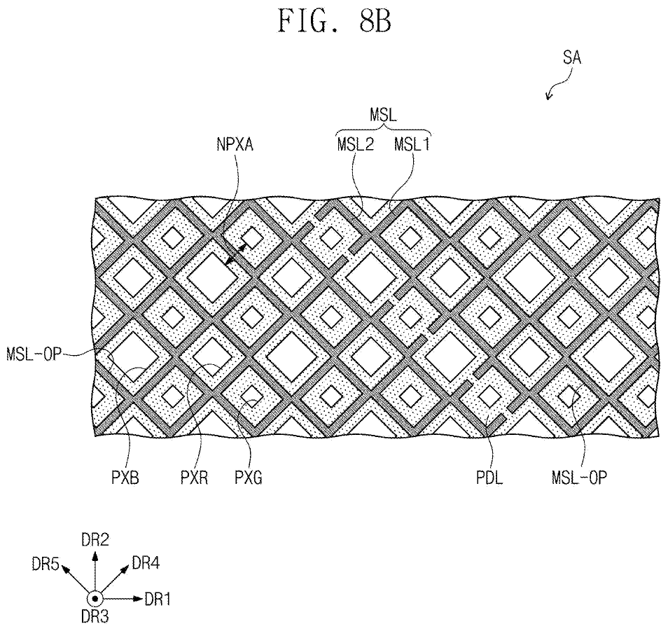

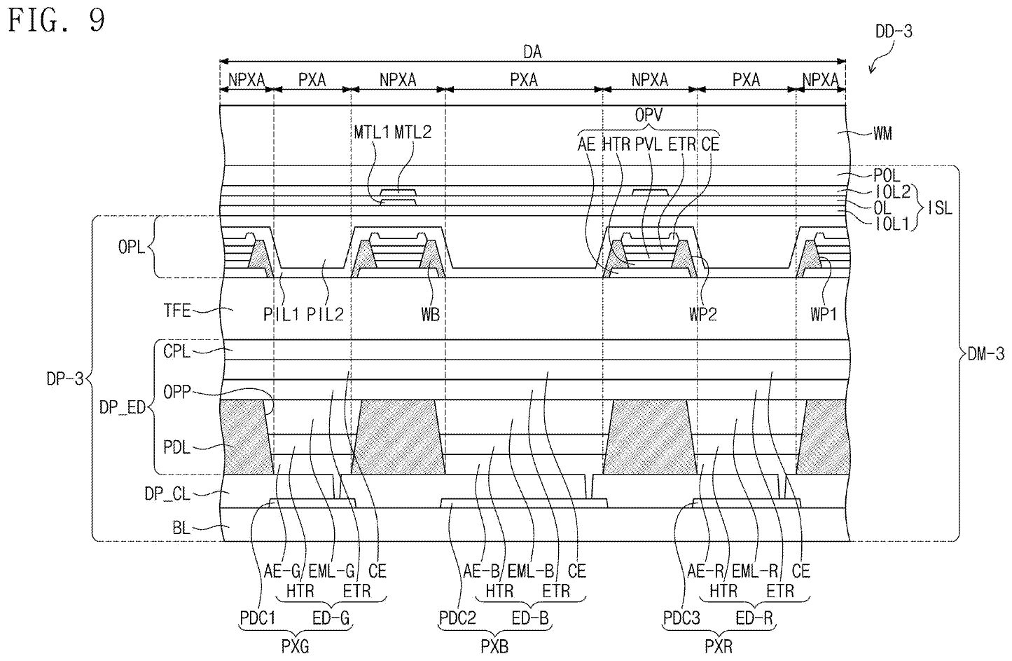

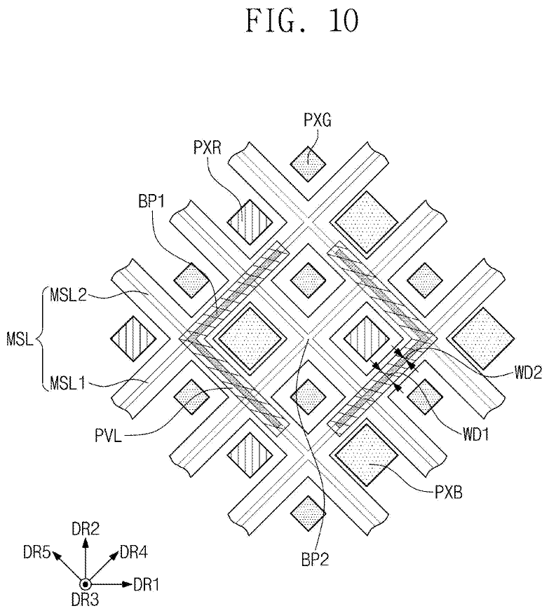

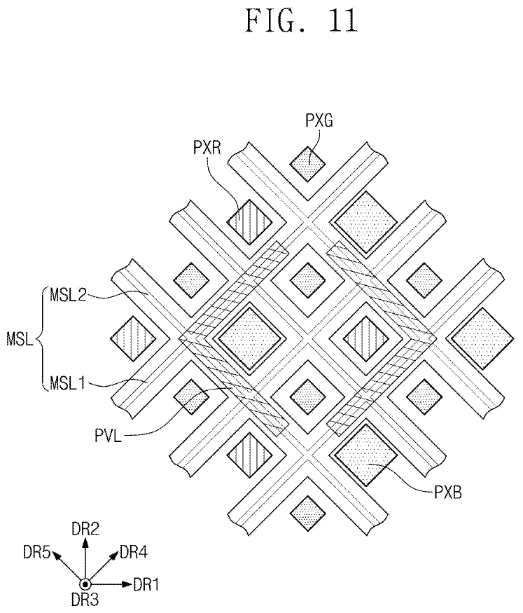

FIG. 8A is a plan view of an input detection layer according to an embodiment of the inventive concept. FIG. 8B is an enlarged plan view of a region of an input detection layer according to an embodiment of the inventive concept. FIG. 9 is a cross-sectional view of a display device according to an embodiment of the inventive concept. FIG. 10 is a plan view illustrating a spatial arrangement between an input detection layer and an optical photovoltaic layer according to an embodiment of the inventive concept. FIG. 11 is a plan view illustrating a spatial arrangement between an input detection layer and an optical photovoltaic layer according to an embodiment of the inventive concept.

The same/similar reference numerals are used for the same/similar configurations as those described with reference to FIGS. 1A to 6B, and redundant descriptions are omitted.

Referring to FIG. 8A, the input detection layer ISL according to an embodiment may include a first detection electrode TE1, a second detection electrode TE2, a first signal line SL1, a second signal line SL2, and a detection pad part TDD including detection pads T-PD.

The first detection electrode TE1 extends along the first direction DR1. A plurality of first detection electrodes TE1 may be provided and arranged along the second direction DR2. The first detection electrode TE1 may include a plurality of first detection patterns SP1 arranged along the first direction DR1 and bridge patterns BP1 disposed between adjacent first detection patterns SP1 and connecting the adjacent first detection patterns SP1 to each other.

The second detection electrode TE2 may be insulated from the first detection electrode TEL. The second detection electrode TE2 extends along the second direction DR2. A plurality of second detection electrodes TE2 may be provided and arranged along the first direction DR1. The second detection electrode TE2 includes a plurality of second detection patterns SP2 arranged along the second direction DR2 and conductive patterns BP2 disposed between the second detection patterns SP2. The second detection patterns SP2 and the conductive patterns BP2 may be patterned through the same process and provided in an integral shape (or form).

The input detection layer ISL may detect an external input by detecting a change in mutual capacitance between the first detection electrode TE1 and the second detection electrode TE2, or detect an external input by detecting a change in self capacitance of each of the first detection electrode TE1 and the second detection electrode TE2. The input detection layer ISL according to an embodiment of the inventive concept may detect an external input in various ways, and is not limited to any one detection schema.

The first signal line SL1 is connected to the first detection electrode TE1. The first signal line SL1 may be disposed in the peripheral area NSA and may not be visually recognized from the outside. The second signal line SL2 is connected to the second detection electrode TE2. The second signal line SL2 is disposed in a peripheral area NSA and may not be visible from the outside.

In this embodiment, one first detection electrode TE1 may be connected to two first signal lines SL1. A first end and a second end of the one first detection electrode TE1 may be connected to different first signal lines SL1 and may be connected to two detection pads T-PD. Accordingly, even if the first detection electrode TE1 has a relatively long length compared to the second detection electrode TE2, an electrical signal may be uniformly applied to the entire area. Accordingly, the input detection layer ISL may provide a uniform external input detection environment for the entire active area AA regardless of the shape.

In addition, the second detection electrode TE2 may also be connected to the two second signal lines TL2, and each of the first detection electrode TE1 and the second detection electrode TE2 may be connected to only one signal line. The input detection layer ISL according to an embodiment of the inventive concept may be driven in various ways, and is not limited to any one driving technique.

The detection pad part TDD is a part to which the flexible circuit board TF is connected, and detection pads T-PD of the detection pad part TDD are connected to pads included in the flexible circuit board TF. The detection pad part TDD may pass through insulating layers included in the input detection layer ISL and may be disposed on the display panel DP. Accordingly, a dead space for forming a detection pad part TDD in the input detection layer ISL may be reduced.

FIG. 8B shows a relationship between detection electrodes TE1 and TE2 included in the input detection layer ISL and pixels PXB, PXR, and PXG included in the display panel DP in detection area SA.

The input detection layer ISL according to the inventive concept may include a plurality of conductive lines MSL1 and MSL2 extending in the fourth and fifth directions DR4 and DR5. The conductive lines MSL1 and MSL2 do not overlap the pixels PXB, PXR, and PXG and overlap the non-emission area NPXA. Accordingly, display openings OP formed in the pixel defining layer PDL may overlap with the corresponding mesh openings MSL-OP.

The conductive lines MSL1 and MSL2 may be connected to each other to have a mesh shape. The conductive lines MSL1 and MSL2 form a plurality of mesh openings MSL-OP. The line width of the conductive lines MSL1 and MSL2 may be several micrometers to several nanometers. The mesh openings MSL-OP may correspond one-to-one to the pixels PXB, PXR, and PXG.

Referring to FIG. 9, a display device DD-3 according to an embodiment may include a display module DM-3 and a window WM. The display module DM-3 may include a display panel DP-3, an input detection layer ISL, and an optical member POL. The display panel DP-3 may further include a base layer BL, a circuit layer DP_CL, a display element layer DP_ED, an encapsulation layer TFE, and a solar cell layer OPL. A stacked structure of the display device DD-3 described with reference to FIG. 9 may correspond to the display device DD-3 described with reference to FIG. 2C.

The display panel DP-3 according to the present embodiment may further include the solar cell layer OPL disposed on the encapsulation layer TFE. The solar cell layer OPL may include a first cell insulating layer PIL1, a second cell insulating layer PIL2, a partition wall WB, and a photovoltaic element OPV.

The first cell insulating layer PIL1 may be directly disposed on the encapsulation layer TFE. The first cell insulating layer PIL1 may include an inorganic material.

The second cell insulating layer PIL2 may be disposed on the first cell insulating layer PIL1 to cover the photovoltaic element OPV. The second cell insulating layer PIL2 may provide a flat surface on which an input detection layer ISL is disposed. The second cell insulating layer PIL2 may include an organic material.

The partition wall WB is disposed on the first cell insulating layer PIL1 and may overlap the non-emission area NPXA. A first partition wall opening WB1 and second partition wall openings WP2 may be formed in the partition wall WB. An inner surface of the partition wall WB may form a first partition wall opening WB1, and an outer surface of the partition wall WB may form second partition wall openings WP2. The inner side of the partition wall WB may be formed by the sides facing each other among the sides of the partition wall WB overlapping the non-emission area NPXA, and the outer surface of the partition wall WB may be formed by side surfaces facing each other among sides overlapping the emission areas PXA. Accordingly, the first partition wall opening WB1 may correspond to the non-emission area NPXA, and each of the second partition wall openings WP2 may correspond to the emission areas PXA. The partition wall WB may include an organic material.

The photovoltaic element OPV may include a first electrode AE (or first cell electrode), a second electrode CE (or second cell electrode), and an optical photovoltaic layer PVL. At least a portion of the first electrode AE may be exposed by the first partition wall opening WP1. An optical photo voltaic layer PVL may be disposed on the first partition wall opening WP1.

The photovoltaic element OPV according to an embodiment may include a hole control layer HTR and an electron control layer ETR. The hole control layer HTR may be disposed between the first electrode AE and the optical photo voltaic layer PVL, and the electron control layer ETR may be disposed between the optical photovoltaic layer PVL and the second electrode CE.

In this embodiment, the input detection layer ISL may be disposed on the solar cell layer OPL. The input detection layer ISL may include a first detection insulating layer IOL1, a first conductive layer MTL1, a second detection insulating layer IOL2, a second conductive layer MTL2, and a third detection insulating layer IOL3.

Each of the first conductive layer MTL1 and the second conductive layer MTL2 may have a single-layer structure or may include a plurality of patterns having a multi-layer structure stacked in a thickness direction. The single-layered conductive layer may include a metal layer or a transparent conductive layer. The plurality of conductive lines MSL1 and MSL2 may be disposed in the second conductive layer MTL2, and the conductive lines may cross each other to form the mesh openings MSL-OP (see FIG. 8B).

According to an embodiment, the first detection patterns SP1, the second detection patterns SP2, and the connection patterns BP2 described with reference to FIG. 8A may be included in the second conductive layer MTL2 and composed of a plurality of conductive lines MSL1 and MSL2 and the bridge pattern BP1 may be included in the first conductive layer MTL1.

FIG. 9 further shows the red pixel PXR may include a third pixel driving unit PDC3 and a red light emitting element ED-R. The red light emitting element ED-R may include a first electrode AE-R connected to the third pixel driving unit PDC3, a second electrode CE, and a light emitting layer EML-R. In addition, the red light emitting element ED-R may include a hole control layer HTR, and an electron control layer ETR.

FIGS. 10 and 11 show the spatial arrangement of a bridge pattern BP1 included in the first conductive layer MTL1, a plurality of conductive lines MSL1 and MSL2 included in the second conductive layer MTL2, an optical photo voltaic layer PVL of the photovoltaic element OPV, and a second electrode CE. FIG. 10 shows an area where the bridge pattern BP1 is disposed, and FIG. 11 shows an area where the bridge pattern BP1 is not disposed.

Referring to FIGS. 10 and 11, the optical photo voltaic layer PVL of the photovoltaic element OPV according to an embodiment is included in the second conductive layer MTL2 and has a shape corresponding to the plurality of conductive lines MSL1 and MSL2. Accordingly, the optical photo voltaic layer PVL of the photovoltaic element OPV may be disposed to completely overlap the non-emission area NPXA.

In this embodiment, the second electrode CE (or second cell electrode) of the photovoltaic element OPV may have a shape corresponding to the bridge pattern BP1. According to an embodiment, a line width WD1 of the second electrode CE may be greater than a line width WD2 of the bridge pattern BP1.

According to this embodiment, since the optical member POL is disposed on the input detection layer ISL, the amount of sunlight incident to the transmission area TA (see FIG. 1A) of the window WM may be large. In addition, since the optical photo voltaic layer PVL of the photovoltaic element OPV is disposed in the entire area overlapping the non-emission area NPXA within the display area DA, the display device DD-3 with improved power consumption may be provided.

Since the display device according to an embodiment of the inventive concept includes an additional energy source included in the display panel, it is possible to provide a display device with improved power consumption.

Although the embodiments of the inventive concept have been described, it is understood that the inventive concept should not be limited to these embodiments but various changes and modifications may be made by one ordinary skilled in the art within the spirit and scope of the inventive concept as hereinafter claimed.

What is claimed is:

1. A display device comprising a display panel including a display area including emission areas and a non-emission area adjacent to the emission areas,
wherein the display panel comprises:
a pixel defining layer that includes first openings corresponding to the emission areas and a second opening corresponding to the non-emission area;
light emitting elements each including a first electrode, a second electrode, and a light emitting layer disposed between the first electrode and the second electrode, wherein each of the light emitting elements is disposed in a corresponding one of the first openings; and
a photovoltaic element including a first cell electrode, a second cell electrode, and an optical photovoltaic layer disposed between the first cell electrode and the second cell electrode, wherein the photovoltaic element is disposed in the second opening.

2. The display device of claim 1, wherein the first electrodes and the first cell electrode are disposed on the same layer.

3. The display device of claim 1, wherein the second electrode and the second cell electrode are integral.

4. The display device of claim 3, further comprising a protection layer disposed on the second electrode and the second cell electrode.

5. The display device of claim 1, wherein the second opening is provided in plural, and the first cell electrode and the optical photovoltaic layer are provided in plural,
wherein a portion of each of the first cell electrodes is disposed in a corresponding second opening among the second openings, and each of the optical photovoltaic layers is disposed in a corresponding second opening among the second openings.

6. The display device of claim 5, wherein the pixel defining layer overlaps the non-emission area and forms third openings spaced apart from the second openings,
wherein the display panel comprises optical sensors each including a light detection element including a first sensor electrode, a second sensor electrode, and a light receiving layer disposed between the first sensor electrode and the second sensor electrode and disposed in a corresponding third opening among the third openings, and a sensor driving unit including at least one transistor.

7. The display device of claim 6, wherein an area of at least one of the second openings and an area of at least one of the third openings are different from each other.

8. The display device of claim 1, wherein the second opening is a single opening,
wherein a shape of the optical photovoltaic layer corresponds to a shape of the non-emission area.

9. The display device of claim 1, further comprising an encapsulation layer including a first inorganic layer covering the light emitting elements, a second inorganic layer, and an organic layer disposed between the first inorganic layer and the second inorganic layer.

10. The display device of claim 9, further comprising an input detection layer including conductive layers and a detection insulating layer, and disposed on the encapsulation layer.

11. The display device of claim 10, further comprising a color filter layer including a light blocking layer overlapping the pixel defining layer and color filters overlapping a corresponding emission area among the emission areas.

12. The display device of claim 10, further comprising an optical member including an antireflection film, a polarizing film, or a gray filter and disposed on the input detection layer.

13. The display device of claim 1, wherein the photovoltaic element further comprises a cell hole control layer disposed between the first cell electrode and the optical photovoltaic layer and a cell electron control layer disposed between the optical photovoltaic layer and the second cell electrode.

14. The display device of claim 13, wherein each of the light emitting elements further comprises a hole control layer disposed between the first electrode and the light emitting layer and an electron control layer disposed between the light emitting layer and the second electrode,
wherein the electron control layer, the cell electron control layer, the hole control layer, or the cell hole control layer has an integral shape.

15. A display device comprising a display panel including a display area including emission areas and a non-emission area adjacent to the emission areas,
wherein the display panel comprises:
a pixel defining layer including openings that correspond to respective emission areas and overlap the non-emission area;
light emitting elements each including a first electrode, a second electrode, and a light emitting layer disposed between the first electrode and the second electrode, wherein each of the light emitting elements is disposed in a corresponding one of the openings;
an encapsulation layer covering the light emitting elements;
a partition wall layer including a first partition wall opening overlapping a portion of the pixel defining layer and second partition wall openings corresponding to respective openings,
wherein the partition wall layer is disposed on the encapsulation layer; and
a photovoltaic element including a first cell electrode, a second cell electrode, and an optical photovoltaic layer disposed between the first cell electrode and the second cell electrode,
wherein the photovoltaic element is disposed in the first partition wall opening.

16. The display device of claim 15, further comprising a cell inorganic layer disposed on the encapsulation layer and covering the photovoltaic element, and a cell organic layer disposed on the cell inorganic layer.

17. The display device of claim 16, further comprising:
an input detection layer including a first detection insulating layer disposed on the cell organic layer;
a first conductive layer overlapping the non-emission area and disposed on the first detection insulating layer;
a second detection insulating layer disposed on the first detection insulating layer and covering the first conductive layer;
a second conductive layer including a plurality of conductive lines overlapping the pixel-defining film and disposed on the second detection insulating layer; and
a third detection insulating layer disposed on the second conductive layer and covering the second conductive layer.

18. The display device of claim 17, wherein the conductive lines have a mesh shape, and
wherein the optical photovoltaic layer has a shape corresponding to the mesh shape.

19. The display device of claim 17, wherein the first conductive layer comprises a bridge pattern connected to corresponding conductive lines among the conductive lines through a contact hole in the second detection insulating layer, and
wherein the second cell electrode has a shape corresponding to the bridge pattern.

20. The display device of claim 19, wherein a line width of the second detection electrode is greater than a line width of the bridge pattern.
